(19) United States
(12) Patent Application Publication
(10) Pub. No.: US 2026/0121096 A1
(43) Pub. Date: Apr. 30, 2026

(54) Redox Tolerant Fuel Electrode for Solid Oxide Electrochemical Cells and Stacks

(71) Applicant: Oxeon Energy, LLC, North Salt Lake, UT (US)

(72) Inventors: S. Elangovan, South Jordan, UT (US); Joseph Hartvigsen, Kaysville, UT (US); Tyler Hafen, West Jordan, UT (US); Dennis Larsen, West Valley City, UT (US); Jenna Pike, Salt Lake City, UT (US); Taylor Rane, Salt Lake City, UT (US)

(21) Appl. No.: 18/892,324

(22) Filed: Sep. 20, 2024

(51) Int. Cl. H01M 8/12; H01M 4/86; H01M 4/88; H01M 4/90

(52) U.S. Cl. CPC H01M 8/12; H01M 4/8835; H01M 4/8885; H01M 4/9033; H01M 2004/8694; H01M 2008/1293

(57) ABSTRACT

A fuel electrode and systems containing the electrode are disclosed. A fuel electrode for use in a solid oxide electrochemical apparatus includes an electron conductor and an oxygen ion conductor. The electron conductor includes Nickel (Ni), Copper (Cu), and Magnesium oxide (MgO). The oxygen ion conductor includes doped Ceria. The fuel electrode includes a cermet current collector that also includes Nickel (Ni), Copper (Cu), Magnesium oxide (MgO), and doped ceria. The current collector also includes metal that is less prone to oxidization, such as certain precious metals. A solid oxide electrochemical cell includes the fuel electrode, an oxygen electrode, and a power supply in operable communication with both electrodes. A method of operating the solid oxide electrochemical cell as either a solid oxide electrolysis cell or a solid oxide fuel cell includes reducing the fuel electrode, if it becomes oxidized, without having to dismantle or replace the fuel electrode.

### GOVERNMENT SUPPORT

This application and certain embodiments described herein were made with government support under NASA SBIR contract number 80NSSC19C0114. The US Government may have rights in this invention.

### TECHNICAL FIELD

The present disclosure relates to solid oxide fuel electrodes for use in electrochemical cells such as solid oxide electrolyzer cells and solid oxide fuel cells. More particularly, the present disclosure relates to solid oxide fuel electrodes that are capable of being re-reduced and reused should the electrochemical cell lose performance due to oxidation of the solid oxide fuel electrode.

### BACKGROUND

Solid oxide fuel electrodes are used in electrochemical cells as part of electrochemical systems that perform electrolysis on feed streams such as steam and carbon dioxide (solid oxide electrolysis cells or SOEC). Electrolytic cells are often used to decompose chemical compounds, in a process called electrolysis. Electrolysis of oxidized chemicals to generate unoxidized species is a means of generating fuels while simultaneously producing high purity oxygen. A classic example is the generation of hydrogen and oxygen using water electrolysis. In the case of high temperature solid oxide cells, the water is fed to the fuel electrode in the form of steam. When driven by an external source of voltage, oxygen atom from the steam molecule is ionized by combining with a pair electrons and the oxygen ion moves through a solid oxide electrolyte leaving behind hydrogen molecule on the fuel electrode side. The oxygen ion travels through the electrolyte towards the oxygen electrode on the opposite side of the electrolyte and forms an oxygen atom by releasing electrons. Two oxygen atoms combine to produce an oxygen molecule. The electrons travel through an external circuit back to the fuel electrode. Thus, the steam electrolysis process using a solid oxide electrolyte produces hydrogen on the fuel electrode side and oxygen on the oxygen electrode side. Similarly, when a hydrogen ion (proton) conducting solid electrolyte is used, hydrogen atoms from water molecule is ionized by releasing an electron. The proton moves through the solid electrolyte leaving behind an oxygen atom which forms an oxygen molecule. The proton reaches the opposite electrode, picks up an electron to form hydrogen molecule. Irrespective of the electrolyte type, either an oxygen ion conductor or proton conductor, the steam electrolysis process results in oxygen on the oxygen electrode side and hydrogen on the fuel electrode side. As the solid electrolyte only allows a specific ion, either oxygen ion or proton depending on the electrolyte type, the process results in high purity gas products.

These same solid oxide fuel electrodes in the same electrochemical cell systems can also be fed fuels such as hydrogen, syngas (a mixture hydrogen and carbon monoxide), and ammonia to create electricity electrochemically (solid oxide fuel cells or SOFC). These fuels are fed to the fuel electrode, and air or other oxidant gas is fed to the oxygen electrode. A catalyst ionizes the oxygen from air to form oxygen ions by picking up electrons from an external circuit. The oxygen ions move through the electrolyte to the fuel electrodes, oxidizes hydrogen and carbon monoxide to form steam and carbon dioxide while releasing electrons to the external circuit. The process thus creates electric power through the external circuit. When a proton conducting solid electrolyte is used, hydrogen molecule is ionized to form protons which move through the electrolyte, reacts with oxygen on the opposite electrode to form steam. The process releases electrons to the external circuit creating electric power. The electrochemical oxidation of fuels also produce heat along with electric power.

Electrochemical cells that can run in both SOEC and SOFC mode with the same fuel electrode, oxygen electrode, and electrolyte set up are sometimes called regenerative or reversible fuels cells or SOEC/SOFC systems. When these cells are capable of running at high temperatures, they can provide high electrical efficiency, flexibility to electrolyze carbon dioxide, steam or both, and the ability to generate power by operating in fuel cell mode without changing the electrodes or electrocatalysts.

The desired catalyst for SOEC/SOFC systems that electrolyze CO₂ and/or steam to produce hydrogen, oxygen, carbon monoxide, and/or syngas, and that create electricity by using fuel feeds such as hydrogen and/or syngas as a feed, is nickel. It has been shown that nickel-based electrodes have superior catalytic activity to electrolyze CO₂ and/or steam as cathode in SOEC mode of operation and reversibility to function as an anode in fuel cell (SOFC) mode of operation.

One of the major operational challenges facing prior art SOEC/SOFC high temperature electrochemical systems, however, is the oxidation of nickel in the nickel-ceramic structure of the fuel electrode to form nickel oxide (NiO). For example, when such prior art systems are operating in SOEC mode with carbon dioxide (CO₂) and/or steam as the feed stream, the fuel electrode will oxidize and deteriorate over a relatively short amount of time. When the fuel electrode experiences repeated reduction-oxidation (redox) reactions and heating and cooling cycles, the problem is exacerbated. Oxidizing the nickel layer to nickel oxide and reducing back to nickel will make it lose its physical integrity and will result in loss of electrical contact. The result to the cell or cell stack is the reduction or complete loss of electrochemical cell performance costing time and money in lost revenues, costly or impossible repairs, and extra labor costs.

One attempt to overcome this oxidation problem is the use of materials other than nickel that are not prone to oxidation/reduction with changes in oxygen partial pressure of fuel electrode gas. Typical attempts include non-stoichiometric oxides and precious metals. While this approach may address the redox problem, these materials do not have the electrocatalytic properties needed for the reduction of CO₂ and steam. These attempts require the high fuel electrode polarization of oxides (e.g., materials with the fluorite crystal structure such as doped ceria; perovskites such as La(Sr)Cr(Mn)O3-∂; double perovskites such as Sr2(FeMo)2O6-∂). They also require noble metals (e.g., Pt, Pd, or their alloys), all of which necessitate a much larger total cell area for a given oxygen production rate and introduce new performance degrading mechanisms such as Pt de-wetting and coarsening.

Other attempts to overcome the problem of prior art systems include co-feeding a reducing gas when electrolyzing CO₂ and/or steam to prevent the nickel from oxidizing. The reducing gas (typically CO and/or H₂) needs to come from an external reducing gas source or from product recycling, necessitating additional complexity and cost to the overall system design and cell or cell stack operation. However, when conditions or circumstances occur that reduce or eliminate the availability of reducing gas, the fuel electrode could oxidize and result in irreversible deterioration of fuel electrode, and subsequently cell or stack performance. This could also occur if there is a substantial delay in the start of the electrolysis operation to produce the reducing gas for recycling the reduction gas as a feed.

Another problem with prior art SOEC/SOFC electrochemical systems using nickel is that the nickel goes through a substantial volume change during oxidation that may cause delamination of the fuel electrode from adjacent layers. When the oxidized fuel electrode is reduced to nickel metal, the SOEC/SOFC system may not recover performance if delamination occurs between the electrode and the electrolyte or between electrode layers during oxidation and reduction cycles.

Additionally, prior art SOEC/SOFC systems using nickel are not available for remote or autonomous use, because the oxidation of the fuel electrode either cannot be re-reduced without an external gas source, or because the oxidation of the fuel electrode cannot be re-reduced without deteriorating.

Accordingly, what is needed is fuel electrode that can be oxidized and reduced while still maintaining sufficient SOEC/SOFC cell and stack product generation and stability. What is needed is a fuel electrode that minimizes the large expansion and contraction of nickel during oxidation and reduction respectively, which can cause delamination and deterioration. What is needed is a fuel electrode with a composition that reduces grain coarsening which can also cause deterioration or destruction of the fuel electrode due to delamination, and reduced performance due to a lower catalytic surface area, among other things. What is needed is a fuel electrode material with oxide dispersion that reduces coarsening and oxidation/reduction related deterioration of the fuel cell. What is also needed is a SOEC/SOFC cell and stack configuration with a fuel electrode that will allow for the re-reduction of an oxidized fuel electrode and the restart or continuation of the SOEC/SOFC cell and/or stack without the need of a reducing gas from an external source. What is needed is a fuel electrode that contributes to the robustness, stability, and performance of the cells and stacks that contain them.

Embodiments of such a fuel electrode and electrochemical cells and stacks of cells containing such fuel electrodes, along with methods of manufacture and use, are claimed and described herein.

### BRIEF SUMMARY

Embodiments of a fuel electrode and cell and cell stack systems containing a redox tolerant fuel electrode are disclosed. A fuel electrode for use in a solid oxide electrochemical apparatus includes an electron conductor and an oxygen ion conductor. In one embodiment, the fuel electrode includes a cermet material where the ceramic portion includes doped ceria configured to conduct oxygen ions through the fuel electrode and the metal portion is configured to conduct electrons through the fuel electrode.

The fuel electrode may include nickel. In one embodiment the nickel includes an oxide dispersion. The oxide may include magnesium oxide dispersed within the grains of nickel. In one embodiment, the electron conductor also includes copper. The ratio of metal to magnesium oxide in the fuel electrode may range from about 99:1 to about 60:40. In another embodiment, the ratio of nickel to copper in the fuel electrode may range from about 99:1 to about 40:60. In yet another embodiment the ratio of electron conductor to oxygen conductor in the fuel electrode ranges from about 70:30 to about 30:70.

In one embodiment, the fuel electrode may include a current collector. The current collector may be an oxidation resistant cermet material. In one embodiment, the current collector includes similar material to the fuel electrode material. The current collector may include one or more of nickel, magnesium oxide and copper. The cermet material may include doped ceria. The current collector may be in the form of a felt, mesh, printed ink, foam, and the like, and may be used to electrically connect the fuel electrode to an energy supply of an electrochemical cell or to an interconnect of a stack of cells. In other embodiments, the current collector may include one or more precious or non-precious metals.

In one embodiment, the fuel electrode is part of an electrochemical cell. The electrochemical cell may function as both a solid oxide electrolysis cell and a solid oxide fuel cell (SOEC/SOFC). The SOFC/SOEC cell may include the fuel electrode and an oxygen electrode in operable communication with an electrolyte. In one embodiment the fuel electrode and oxygen electrode are screen printed to the electrolyte. In another embodiment, fuel electrode material may first be infiltrated into a backbone structure that may include an yttria stabilized zirconia. In another embodiment fuel electrode material may be infiltrated into a backbone structure that consists of oxide dispersed nickel mixed with an yttria stabilized zirconia cermet. In one embodiment, the zirconia may be stabilized with one or more of scandia, ytterbia, magnesia, calcia, and the like. In other embodiments, the backbone structure may include ceria or a doped ceria cermet. The dopant may include samaria. The infiltrated or embedded matrix may then be attached to an electrolyte.

In certain embodiments, electrochemical cells with the fuel electrodes described herein may be assembled into stacks where the electrochemical cells are connected with interconnects that attach to a power supply in electrolysis cell operation or an electrical load for fuel cell operation.

### BRIEF DESCRIPTION OF THE SEVERAL VIEWS OF THE DRAWINGS

FIG. 1 is a schematic diagram of a fuel electrode with a current collector in accordance with one or more embodiments of the disclosure;

FIG. 2 is a schematic diagram of a fuel electrode and current collector attached to an electrolyte with an oxygen electrode and power supply in an electrochemical cell configuration in accordance with one or more embodiments of the disclosure;

FIG. 3 is a schematic diagram of a plurality of electrochemical cell configured in an electrochemical cell stack in accordance with one or more embodiments of the disclosure;

FIG. 4 is a schematic flow chart of a method of manufacturing the fuel electrode depicted in FIG. 1;

FIG. 5 is a schematic flow chart of a method of using embodiments of the electrochemical cell of FIG. 2;

FIG. 6 is a graph showing the temperature programmed reduction of oxide dispersed NiO;

FIG. 7 is an x-ray diffraction (XRD) scan of 4 NCC variants and NMCS showing Cu remaining as a dopant in the NiO crystal structure and with no undesired or precipitated phases seen in the compositions;

FIG. 8 is an XRD scan of NCC80 powder compared against reference patterns for NiO, doped CeO₂, and two forms of copper-oxide;

FIG. 9 is a series of graph sequences showing TGA test results of the one embodiment of a fuel electrode material for two cycles of H2 reduction and CO2 oxidation;

FIG. 10 is a series of graph sequences showing TGA test results of the one embodiment of a fuel electrode material for H₂ CO₂ CO reduction CO₂ oxidation;

FIG. 11 is a graph showing TGA H2 reduction data comparing NMZ fuel electrode backbone and MgO oxide-dispersant levels;

FIG. 12 is a schematic diagram showing of one side of a stack layers (CO2 side), pre-build and post-build;

FIG. 13 is graph showing the first 500 hours of NCC85 bulk fuel electrode button cell (BC) testing;

FIG. 14 is a graph showing one embodiment of Bulk NCC90 fuel electrode through long-term operation and multiple full redox cycles;

FIG. 15 is a graph showing one embodiment of Bulk NCC85 fuel electrode through long-term operation and multiple full redox cycles;

FIG. 16 is a graph showing Bulk NCC90 fuel electrode recovery from full oxidation;

FIG. 17 is a graph showing Bulk NCC85 fuel electrode recovery from full oxidation;

FIG. 18 is a graph comparison showing time required to reduce oxidized Ni in the NMZ backbone containing different quantities of MgO dispersion;

FIG. 19 is a graph showing LabView data from a test of a button cell (BC-23-3) that was rapidly cooled from operating temperature to room temperature, and then rapidly returned to operating temperature (800 C);

FIG. 20 is a graph showing rapid thermal cycle performance of a button cell with a fuel electrode consisting of NMZ backbone that was infiltrated with NCC85 in 6 infiltration-calcination cycles;

FIG. 21 is a graph showing performance of a button cell with NMZ backbone that was infiltrated with NCC85 in 12 infiltration-calcination cycles and tested in rapid thermal cycle conditions;

FIG. 22 is a graph showing performance of a button cell that was tested in rapid thermal cycle conditions for an embodiment of an infiltrated fuel electrode with a current collector;

FIG. 23 is a graph showing the performance of an electrochemical cell embodiment with 72 total rapid thermal cycles;

FIG. 24 is a graph showing the initial performance of an embodiment of a stack with gas flow changes;

FIG. 25 is a graph showing partial redox cycling data for an embodiment of a stack;

FIG. 26 is a graph showing a partial and full redox cycling data comparison for an embodiment of a stack;

FIG. 27 is a graph showing full current-voltage (IV) sweep data from open current voltage (OCV) to operating voltage after 2^{nd} full redox cycle;

FIG. 28 is a graph showing Linear IV sweep data near operating conditions;

FIGS. 29-52 are graphs showing the performance of embodiments of electrochemical cells described herein in stack form;

FIG. 53 is a table (i.e., Table 2) showing fuel electrode application methods;

FIG. 54 shows pictures of various embodiments of button cells and testing setups; and

FIG. 55 is a table (i.e., Table 6) showing an EIS comparison of NMZ cells BC-23-1 (no infil.) & BC-23-3 (6×NCC85 infil.).

### DETAILED DESCRIPTION

In the following detailed description, reference is made to the accompanying drawings which form a part hereof, and in which are illustrated specific embodiments of the present invention. These embodiments are described in sufficient detail to enable those of ordinary skill in the art to practice the disclosure. It should be understood, however, that the detailed description, while indicating examples of embodiments of the disclosure, are given by way of illustration only and not by way of limitation. Accordingly, various substitutions, modifications, additions rearrangements, or combinations thereof are within the scope of this disclosure.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus or material, or all operations of a particular method.

Additionally, various aspects or features will be presented in terms of systems or devices that may include a number of devices, components, modules, and the like. It is to be understood and appreciated that the various systems and/or devices may include additional devices, components, modules, etc. and/or may not include all of the devices, components, modules etc. discussed in connection with the figures. Accordingly, the present invention is not limited to relative sizes or intervals illustrated in the accompanying drawings.

It is to be understood that although features, characteristics and results may be described in connection with a particular embodiment, phase project, example, and the like, any feature, characteristic, or property of any one embodiment, example, or result may be applicable to any other embodiment, example, or result described herein. Accordingly, all or a portion of any embodiment disclosed herein may be utilized with all or a portion of any other embodiment, unless stated otherwise.

In addition, it is noted that the embodiments may be described in terms of a process that is depicted as method steps, a flowchart, a flow diagram, a schematic diagram, a block diagram, a function, a procedure and the like. Although the process may describe operational steps in a particular sequence, it is to be understood that some or all of such steps may be performed in a different sequence. In certain circumstances, the steps are performed concurrently with other steps.

The terms used in describing the various embodiments of the disclosure are for the purpose of describing particular embodiments and are not intended to limit the disclosure. As used herein, the singular forms are intended to include the plural forms as well, unless the context clearly indicates otherwise. All of the terms used herein, including technical or scientific terms have the same meanings as those generally understood by an ordinary skilled person in the related art unless they are defined otherwise. Terms defined in this disclosure should not be interpreted as excluding the embodiments of the disclosure. Additional term usage is described below to assist the reader in understanding the disclosure.

References to “the invention” or “invention” are not meant to be limiting in scope and should be read to mean “embodiments of the invention.”

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A and B,” “one or more of A and B”, or “A and/or B” as used herein include all possible combinations of items enumerated with them. For example, use of these terms, with A and B representing different items, means: (1) including at least one A; (2) including at least one B; or (3) including both at least one A and at least one B. In addition, the articles “a” and “an” as used herein should generally be construed to mean “one or more” unless specified otherwise or clear from the context to be directed to a singular form.

It will be understood that, when two or more elements are described as being “coupled,” “operatively coupled”, “in communication”, or “in operable communication” with or to each other, the connection or communication may be direct, or there may be an intervening element between the two or more elements. To the contrary, it will be understood that when two or more elements are described as being “directly” coupled with or to another element or in “direct communication” with or to another element, there is no intervening element between the first two or more elements.

Furthermore, “connections” or “communication” between elements may be, without limitation, wired, wireless, electrical, mechanical, optical, chemical, electrochemical, or in any other way two or more elements interact, communicate, or acknowledge each other.

The expression “configured to” as used herein may be used interchangeably with “suitable for,” “having the capacity to,” “designed to,” “adapted to,” “made to,” or “capable of” according to a context.

The word “exemplary” or “example” is used herein to mean “serving as an example or illustration.” Any aspect or design described herein as “exemplary” or as an “example” is not necessarily to be construed as preferred or advantageous over other aspects or designs and is not to be construed as being limited in its scope so as to exclude other examples or exemplary items.

The term “about” is used herein to mean approximately, roughly, around, or in the region of. When the term “about” is used in conjunction with a numerical range, it modifies that range by extending the boundaries above and below the numerical values-set forth. In general, the term “about” is used herein to modify a numerical value above and below the stated value by a variance of 5 percent up or down (higher or lower.

The term “redox tolerant” as used herein, means that the component, apparatus, and/or system described as redox tolerant can withstand at least one cycle of reduction and oxidation and up to several cycles of reduction and oxidation, without loosing its intended function or functionality through deterioration or reduced performance. The term “redox tolerant” used in conjunction with something may also mean that item referred to as redox tolerant is tolerant to multiple oxidation reduction cycles and/or rapid thermal cycling without the loss of electrical or physical characteristics.

The term “solid oxide electrolysis cells” or “solid oxide electrolytic cells” may be referred to as “SOEC” or “SOEC cells.”

The term “solid oxide fuel cells” may be referred to as “SOFC” or “SOFC cells.”

The term “electrochemical cell,” as used herein throughout, includes solid oxide electrolysis cells and solid oxide fuel cells. The term “electrochemical cell” may be used interchangeably with the term “solid oxide electrolysis cells” and “solid oxide fuel cells,” depending on the context. “Electrochemical cells” may be referred to as simply “cells.” The term electrochemical cells, when capable of being used as both a solid oxide electrolysis cell and a solid oxide fuel cell, may be referred to as “regenerative”, “reversible”, or “unitized” cells. Such cells may also be referred to as “SOEC/SOFC,” “SOEC/SOFC cells”, “SOFC/SOEC” “SOFC/SOEC cells,” “SOXE” or “SOXE cells.”

The term “electrochemical cell stack” means a plurality of electrochemical cells arranged in a stack or combined in other ways. This term may be interchangeable with the terms “electrochemical stack,” “cell stack,” or simply “stack.”

The term “fuel electrode” may be m to as a “cathode” when the electrochemical cell in which it may reside is being used in SOEC mode and as an “anode” when the electrochemical cell in which it may reside is being used in SOFC mode.

The term “oxygen electrode” may be referred to as “air electrode.” These terms may be referred to as an “anode” when the electrochemical cell in which it may reside is being used in SOEC mode and as an “cathode” when the electrochemical cell in which it may reside is being used in SOFC mode.

The term “re-reduced” or “reduced” may be used when a component is reduced after having been oxidized or after having already been reduced before being oxidized and reduced again.

The term “upset condition” includes any condition or circumstance or set of conditions or circumstances that may cause the loss of power to an electrochemical cell or cell stack in SOEC mode.

References to elements herein throughout include the element in all of its various forms, unless otherwise indicated. For example, the term “nickel” includes nickel in its various forms, including without limitation oxidized nickel, reduced NiO, nickel alloys, nickel nitrates nickel ions, and the like. By way of further non-limiting example, the term “copper” includes in its various forms, including without limitation oxidized copper, reduced CuO, copper alloys, copper nitrates copper ions, and the like. Similar meanings apply to elements such as magnesium, palladium, cobalt, ceria, zirconia, samaria, platinum, to name but a few.

The term “grain” or “grains” of something include particles, pieces, elements, embodiments, and the like of that thing. By way of non-limiting example, references to grains of nickel include particles of nickel.

The term “oxide dispersed” or “oxide-dispersed,” when used with a material or component means that the material or component has oxide dispersed within it. By way of nonlimiting example, the term “oxide dispersed nickel” includes grains of nickel or grains of nickel alloys having oxide dispersed within it or on the surface of such grains.

The terms “power supply” and “power source” are generally used when describing an electrochemical cell being used as an SOEC or in SOCE mode and the terms “electrical load” or “load” are generally used when describing an electrochemical cell being used as an SOFC or in SOFC mode. However, for electrochemical cells that can operate in SOEC and SOFC mode these terms may be used interchangeably, along with terms like “energy source” and the like for convenience.

As used herein, the term “fuel electrode” and “fuel electrode material” may be used interchangeably when the context allows, or for convenience. For example, references to “fuel electrode” may be to the fuel electrode before its full functional completion. Additionally, references to “fuel electrode material” although in a precursor form may referred to the fuel cell in its final, full functional form.

Like reference numerals may be used to denote like features throughout the specification and figures.

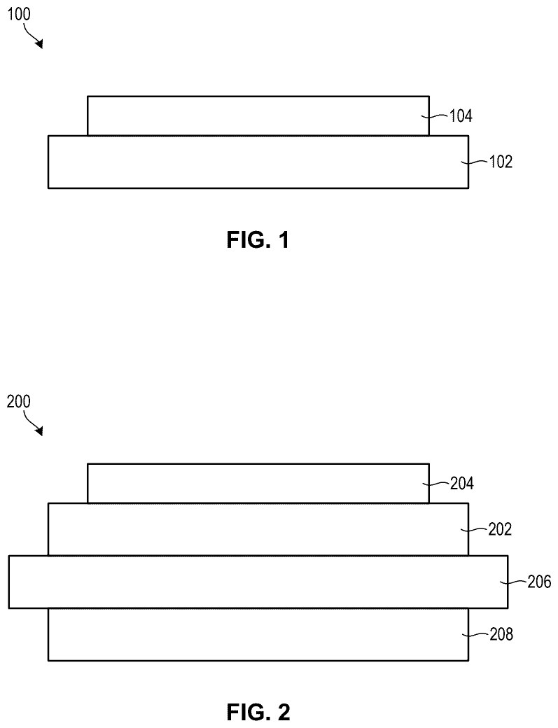

Turning now to FIG. 1, a fuel electrode 100, for use in a solid oxide electrochemical apparatus such as an SOEC and/or SOFC is shown. The fuel electrode 100 may include a fuel electrode material 102. It will be appreciated that the terms fuel electrode 100 and fuel electrode material may be used interchangeably. In one embodiment, the fuel electrode 100 or fuel electrode material 102 includes an electron conductor and an oxygen ion conductor. It will also be appreciated that references to electron conductor includes electron conductor material and references to oxygen, or oxygen ion conductor may be used interchangeably and may include oxygen conductor material, and oxygen ion conductor. These conductors and conductor materials may be part of the fuel electrode 100 and/or fuel electrode material 102.

In one embodiment, the fuel electrode 100 includes a cermet. The electrode material 102 is configured to allow the conduction of electrons and oxygen ions within and/or through the electrode material 102 as part of the electron conductor and oxygen ion conductor respectively when the fuel electrode 100 is connected to power supply or electrical load. In one embodiment, the oxygen conductor and/or a ceramic portion of the cermet may include one or more of doped ceria and doped zirconia. Accordingly, the electrode material 102 may include one or more of doped ceria and doped zirconia. The doped ceria and/or doped zirconia act as an oxygen ion conductor for the fuel electrode 100. In one embodiment, the ceria may be doped with samarium oxide (samaria). The zirconia may be doped with yttria or scandia or other known dopants. The doped ceria used as the ceramic portion of the cermet is configured to impart better catalytic activity, better coke prevention and/or better sulfur tolerance to the fuel electrode 100. The doped ceria also provides an oxygen buffer through the non-stoichiometry of ceria. The ceria is also configured to function as an electrode when nickel is in the oxidized state. The ceria is also configured to function as an oxygen conductor and electron conductor.

The metal portion of the cermet, and/or the electron conductor of the electrode material 102 may include nickel (Ni). In one embodiment, the nickel is oxide-dispersed nickel, or nickel grain with oxide dispersed throughout and/or on the surface of the grain. As will be discussed in greater detail below, the oxide-dispersed nickel reduces the nickel oxidation rate during SOEC and SOFC processes to allow for increased performance and/or stability over prior art SOEC and SOFC fuel electrodes. Using oxide-dispersed nickel helps impart redox tolerance to the fuel electrode.

The electrode material 102 may include one or more promoters. In one embodiment the fuel electrode 100 includes magnesium oxide as a promoter. Accordingly, the electron conductor of the fuel electrode 100 may include magnesium oxide. The magnesium oxide is configured to improve the reactivity of nickel catalysts with oxygen. The magnesium oxide acts as an oxide dispersant. In one embodiment, NiO and MgO form a solid solution over the entire fuel electrode compositional field. When exposed to a reducing gas, only NiO reduces to nickel leaving behind a fine dispersion of magnesium oxide that is interspersed or dispersed within nickel particles or grains. This creates what may be called oxide-dispersed nickel (also referred to herein throughout as “OD nickel” or “ODN”). The oxide dispersion significantly reduces the coarsening rate of nickel particles, an important degradation mechanism in cell operation. The presence of MgO dispersion slows down the oxidation rate of Ni when exposed to oxidizing gases. The presence of a basic oxide, such as MgO, provides additional sulfur tolerance that provides a benefit in typical fuels that contain low to high levels of sulfur species. In one embodiment, a magnesium oxide promoter may also produce a more homogeneous distribution of nickel and/or copper throughout the fuel electrode material. Magnesium oxide dispersion also provides microstructure stability.

In one embodiment, the electron conductor, and thus the fuel electrode material, may include copper. The copper may be used as a promoter to improve the catalyst qualities of the nickel. In one embodiment, the promoter may be a copper nitrate that when heated forms oxides of copper in the fuel electrode. Upon the first passing of a reducing gas and an electrolysis feed, such as, by way of non-limiting example, hydrogen with steam and/or with carbon monoxide with carbon dioxide, the copper oxide is reduced leaving substantially only Cu remaining. The copper is then free to form alloys with nickel and/or decorate the nickel grain surface to enable faster reduction kinetics if an upset condition allowed oxidation of nickel at the feed inlet. In one embodiment, the electron conductor is a mixture of nickel and copper and/or a nickel-copper alloy.

The addition of copper has been shown to increase the reduction rate of nickel oxide after an upset condition allows oxidation of the nickel, or in other words, the copper aids in the re-reduction of the oxidized nickel in the fuel electrode 100 and the faster performance recovery of cell and/or stack systems containing the fuel electrode 100. In one embodiment copper is added to make up at least about 1% of the fuel electrode material. In another embodiment, the amount of copper added results in less than about 20% of the fuel electrode material. In one embodiment, magnesium oxide acts as a dispersed oxide in the combined nickel and copper metals.

In one embodiment, the ratio of Ni:Cu in the electron conductor ranges from about 99:1 to about 40:60. In another embodiment, the ratio of metal:MgO in the electron conductor ranges from about 99:1 to about 60:40. In yet another embodiment, the ratio of Ni and Cu:MgO in the electron conductor ranges from about 99:1 to about 40:60. In yet another embodiment, the ratio of electron conductor to oxygen conductor ranges from about 30:70 to about 70:30.

It is found that the Ni—Cu(MgO)-doped ceria based fuel electrode composition is redox tolerant for both short term and long term exposure to oxidizing gases such as dry CO2. The short term exposure will result in partial oxidation of nickel while the long term exposure will substantially oxidize nickel. In both cases, operation of the cell under an applied voltage generates reducing gases such as carbon monoxide, which reduces nickel oxide to nickel resulting in recovery of electrolysis cell performance.

In one embodiment, the fuel electrode composition includes nickel with MgO dispersion mixed with doped zirconia. The initial layer may be either co-sintered as NiOMgO-doped zirconia and doped zirconia bi-layers followed by reduction to achieve Ni(MgO)-doped zirconia, or it could be deposited on to a pre-sintered electrolyte. A precursor solution to form Ni(MgO)-doped ceria is infiltrated into the presintered or pre-sintered and reduced initial layer. The infiltrated layer may also contain copper resulting in a Ni—Cu(MgO)-doped ceria composition. In one embodiment, an initial Ni(MgO)-doped zirconia layer is well bonded and allows for rapid thermal cycling. The MgO dispersion in nickel provides a stable electrode structure and capability of stability during oxidation-reduction cycling. The infiltrated material provides for higher catalytic activity and enhances performance stability and oxidation-reduction tolerance. The composition of the fuel electrode combines various aspects of materials development to provide stable performance during arduous conditions.

Other promoters may include metal particles such as platinum or palladium that may be used as infiltrated catalysts. Other precious metals may be used as promotors to enhance electron conduction by forming conductive metal alloys with other metals in the fuel electrode composition. Other promoters may include rare earth elements such as praseodymium, cobalt, and the like to improve catalysis during SOEC and/or SOFC operation of cells and stacks employing fuel electrode embodiments disclosed herein.

The fuel electrode 100 or fuel electrode material 102 may be mixed, formed, and/or created in bulk form, where in one embodiment, the fuel electrode material is mixed together. The fuel electrode 100 or fuel electrode material 102 mixture may then be processed in various ways to form a solid or substantially solid fuel electrode. As will be discussed in greater detail below, these processes may include without limitation, printing, heating, sintering, forming as green tape, calcining, cooling, layering, gas or liquid subjugation, lamination, and the like. In another embodiment, the fuel electrode may include a backbone structure (not shown). The backbone structure may be a matrix or skeletal structure or any support structure suitable for receiving all or a portion of the fuel electrode material 102. In one embodiment, the backbone structure may include one or more of doped ceria and doped zirconia. The dopants in certain embodiments may be any of those dopants described herein throughout.

In one embodiment, the fuel electrode 100 may include a current collector 104. The current collector 104 may include the same materials 102 used in the fuel electrode and may be oxidation resistant and have similar redox tolerant characteristics of the fuel electrode 100. The current collector 104 may be part of the fuel electrode 100 or a layer attached to the fuel electrode 100. Both of these configurations may be referred to interchangeably herein throughout as the fuel electrode 100. In one embodiment the current collector 104 is positioned outwardly to be exposed to incoming dry or wet carbon dioxide and/or steam.

In one embodiment, the current collector 104 further comprises a cermet. The current collector may include one or more of nickel, magnesium oxide, and copper. The current collector 104 may also include doped ceria. In certain embodiments, the current collector includes joining material and is configured to function as means of connection to a power supply, and/or cell interconnect to the fuel electrode 100. The current collector 104 composition, in addition to providing electrical contact between the fuel electrode and the interconnect, also provides a catalytic function for the electrochemical process in which it is utilized.

The current collector 104 composition is configured to be tolerant to multiple oxidation reduction cycles as well as rapid thermal cycling without the loss of electrical and physical characteristics. The current collector is also configured to function as an electrode, thereby allowing for the cells and stacks containing the fuel electrode 102 and current collector 104 to function even when the electrode material 102 is oxidized. This configuration allows for the generation of reducing gas in the electrolysis operation that can be used for the re-reduction of oxidized electrode without the need for external reducing gas to recover cell or stack performance.

The current collector and/or fuel electrode may include one or more precious metals mixed with fuel electrode material 102. In one embodiment, the current collector 104 includes a mixture and/or an alloy of silver and palladium with electrode material. In one embodiment the palladium of this mixture ranges from between about 10 to about 40 atom %. In one embodiment, the precious metal is silver. In one embodiment, the current collector material consists of Ni—Cu alloy with the ratio of nickel to copper ranging from about a 95:5 to about 70:30 mixed with doped cerium oxide. In another embodiment, a silver palladium alloy is mixed in the ratio of about 10 to about 50 volume percent electrode material.

The current collector 104 enables stable, long term operation of a solid oxide fuel cells and electrolysis cells and stacks containing the fuel electrode 100 and current collector 104.

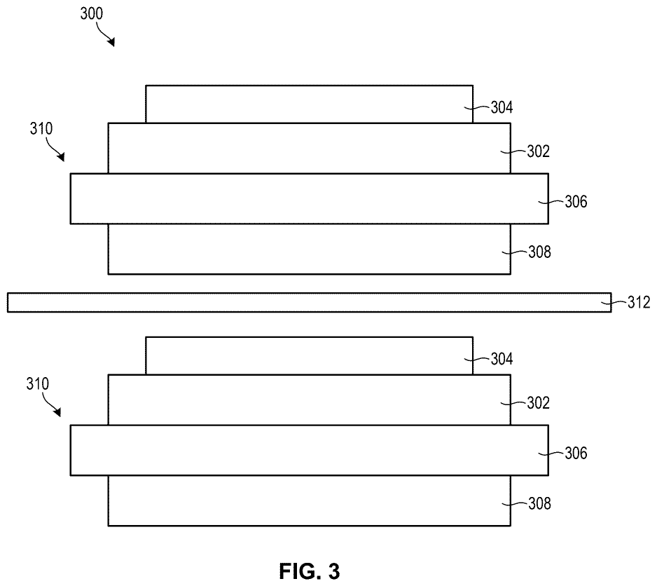

Turning now to FIG. 2, solid oxide electrochemical cell 200 may include a fuel electrode 202 and an oxygen electrode 208 attached to an electrolyte 206. The electrolyte 206 is configured to function in both SOEC and SOFC operational mode. In one embodiment, the electrolyte 206 includes yttria stabilized zirconia. In another embodiment, the electrolyte 206 includes scandia stabilized zirconia electrolyte. The electrochemical cell 200 may be configured to operate as a solid oxide electrolysis cell (SOEC) and a solid oxide fuel cell (SOFC). The electrodes 202 and 208 may be in operable communication with a power supply or an electrical load (not shown).

The fuel electrode 202 may be any of the fuel electrodes described herein throughout. The fuel electrode 202 may include and/or be attached to a current collector 204 of the types described herein throughout. In one embodiment, the fuel electrode 202 may be screen printed to the electrolyte 206 in ways known in the art. In other embodiments, the fuel electrode 202 or fuel electrode material may be structured in a novel way before being attached to the electrolyte 206. Indeed, in some embodiments, fuel electrode material may first be infiltrated into a backbone structure (not shown). The backbone structure may be a porous matrix or skeletal structure configured to receive the fuel electrode material. In one embodiment, the backbone structure is made of porous yttria stabilized zirconia. In another embodiment, the backbone structure is made of porous, oxide dispersed nickel and an yttria stabilized zirconia cermet.

In one embodiment, fuel electrode precursors are infiltrated into the porous backbone structure and the infiltrated backbone structure is sintered on a surface of the electrolyte 206. The fuel electrode precursors may be the components or elements of the fuel electrode material in various states. In one embodiment, the fuel electrode precursor includes oxide dispersed nickel copper alloy combined with a ceria cermet, which is infiltrated into a porous matrix consisting of an oxide dispersed nickel combined with an yttria stabilized zirconia cermet.

The fuel electrode 202 structured as fuel electrode material infiltrated into a porous backbone structure sterically hinders the oxidation front from reaching the active interface, thereby significantly diminishing or removing the likelihood of electrode delamination. Fuel electrodes 200 structured in this way also result in lower oxidation/reduction volume change due to finer Ni/NiO particles within the stable porous matrix. Additionally, fuel electrodes 202 with fuel electrode material infiltrated into a porous backbone may limit disruption to the electrode microstructure from molar volume change of nickel during initial reduction of nickel oxide in the fuel electrode and the high porosity of the skeletal frame can accommodate further volume changes from redox cycling.

In one embodiment, catalyst material in the fuel electrode is not formed as discrete particles but as embedded particles in a host matrix. In one embodiment, this may be achieved by selecting cerium oxide as the matrix and doping it heavily with Pr and Co beyond their solubility limit. Once exposed to high operating temperatures of the cells, the excess dopant will exolve to the surface of the cerium oxide particles. As they are embedded particles and not situated as free particles, they are stable at the operating temperature over time. The composition containing Ce, Pr, and Co cation nitrates can be infiltrated into the sintered porous electrodes followed by heat treatment to form the cerium oxide with exsolved cations. In the fuel electrode the exsolved Pr and Co will stay as metal particles and in the oxygen electrodes they will form oxides of Pr and Co separately or as an oxide of combined Pr and Co.

The oxygen electrode 208 may include a perovskite mixed with one or more of doped zirconia and doped ceria. In one embodiment, the oxygen electrode 208 may be screen printed to the electrolyte 206 in ways known in the art.

The electrochemical cell 200 is configured to be able to re-reduce oxidized fuel electrode material after an upset condition by using gas within the system or produced by the system. Accordingly, the electrochemical cell does not need reducing gas from an external source to re-reduce an oxidized fuel electrode and substantially recover system performance.

The fuel electrode material and composition may also assist in reducing the coking of the fuel cell 202 during SOEC operation. In one embodiment, the electrochemical cell 200, when operating in SOEC mode, is configured to convert at least 50% CO₂ conversion before coking. In one embodiment, the electrochemical cell 200, when operating in SOEC mode, is configured to convert at least 60% CO₂ conversion before coking. In one embodiment, the electrochemical cell 200, when operating in SOEC mode, is configured to convert at least 70% CO₂ conversion before coking. In one embodiment, the electrochemical cell 200, when operating in SOEC mode, is configured to convert about 80% CO₂ conversion before coking.

Turning now to FIG. 3, a solid oxide electrochemical cell stack 300 may include a plurality of the solid oxide electrochemical cells described herein. The individual stacks may include a fuel electrode 302 and oxygen electrode 308 attached or in operable connection with an electrolyte 306. The fuel electrode 302 may include a current collector 304 that is part of or attached to the fuel electrode 302. The stack 300 may include at least one interconnect 312 in fluid communication with a pair of solid oxide electrochemical cells 310. The stack 300 may include a power supply (not shown) in communication with at least one interconnect 312 and/or electrode 302/308. In one embodiment, the interconnect 312 may be in operable communication with the current collector 304.

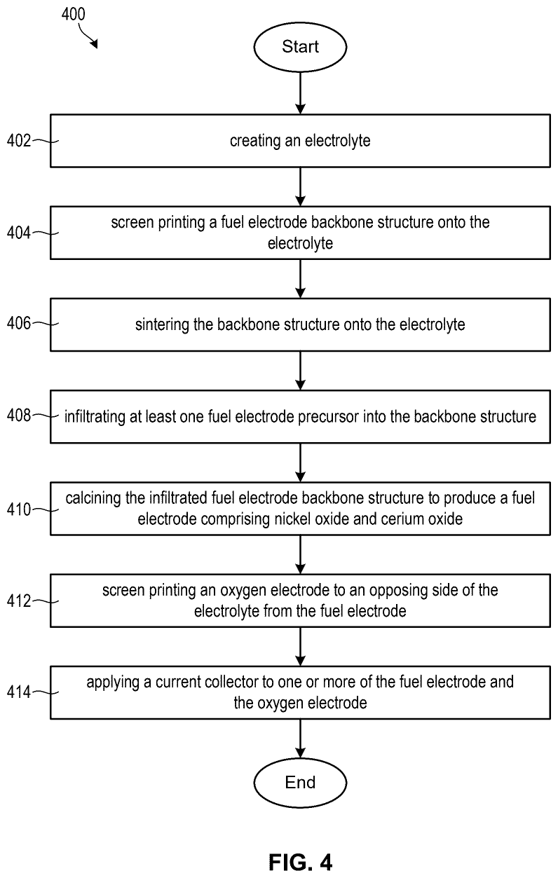

Turning now to FIG. 4, a method of manufacturing 400 a solid oxide electrochemical cell configured to operate as a solid oxide electrolysis cell and a solid oxide fuel cell, wherein the solid oxide electrolysis cell is configured to electrolyze one or more of carbon dioxide and steam is shown. In one embodiment, the method may include the steps of creating an electrolyte 402, screen printing a fuel electrode backbone structure onto the electrolyte 404, sintering the backbone structure to the electrolyte 406, infiltrating at least one fuel electrode precursor into the backbone structure 408, calcining the infiltrated fuel electrode backbone structure to produce a fuel electrode comprising nickel oxide and cerium oxide 410, screen printing an oxygen electrode to an opposing side of the electrolyte from the fuel electrode 412, and applying a current collector to one or more of the fuel electrode and the oxygen electrode 414.

In one embodiment, the current collector comprises one or more of nickel, magnesium oxide, and doped ceria. In another embodiment, the fuel electrode precursor comprises nickel, magnesium, and ceria.

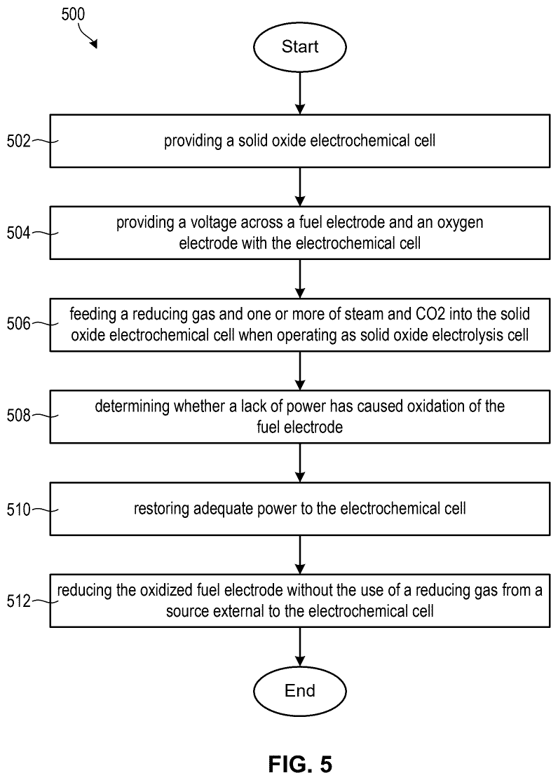

Turning now to FIG. 5, an embodiment of a method 500 of using a solid oxide electrochemical cell may include the steps of providing a solid oxide electrochemical cell 502, providing a voltage across a fuel electrode and an oxygen electrode with the electrochemical cell 504, feeding a reducing gas and one or more of steam and CO2 into the solid oxide electrochemical cell when operating as solid oxide electrolysis cell 506, determining whether a lack of power has caused oxidation of the fuel electrode 508, restoring adequate power to the electrochemical cell 510, and reducing the oxidized fuel electrode without the use of a reducing gas from a source external to the electrochemical cell 512.

In one embodiment, the electrochemical cell includes any of the electrochemical cell embodiments described herein. The electrochemical cell may also include any of the fuel electrodes, oxygen electrodes, and electrolytes described herein.

### Testing Summaries

Certain embodiments demonstrate redox cycling capability for dry CO2 electrolysis and rapid thermal cycling capability. These were to be demonstrated both in button cells and a short stack.

Additional optimization tasks addressed the catalyst composition and the NMZ [Ni(Mg)O—YSZ]layer for infiltrations. Additional button cell testing tasks were long term stability testing in dry CO2 electrolysis, and evaluation of an infiltrated catalyst to determine the possibility of performance recovery. For stack testing, the added tasks were demonstration of reversible SOEC-SOFC operation using H2/H2O, and determination of coking limit for dry CO2 electrolysis. Characteristics of embodiments of the present invention include, without limitation:
Redox Tolerance: Button cells and two stacks were redox cycled by oxidizing the fuel electrode in dry CO2 and recovering performance only using electrolysis-generated CO.
Thermal Cycling: Button cells were thermal cycled in dry CO2 by turning off power to the test furnace and heating the furnace back up at a rate of 15° C./min. Over 70 thermal cycles were performed on a cell with no discernible degradation in performance attributable to thermal cycles. It must be noted that during thermal cycles and before application of cell voltage, the fuel electrode is exposed to the oxidizing condition of dry CO2 and thus the thermal cycling tests inherently included redox cycling. The stack also did not show any degradation attributable to thermal cycling, although high heating rate was not possible due to thermal mass of the stack.
Catalyst Study: Nitrates of Pr and Co may be infiltrated into the electrodes prior to cell or stack heat up. A new catalyst material wherein ceria is the host matrix for Pr and Co was evaluated. After the button cell performance degraded over time, cool down and re-infiltration of the catalyst resulted in performance recovery close to the initial performance.
Reversible Testing: A 10-cell stack was periodically switched between fuel cell and electrolysis modes in H2/H2O fuel with no change in performance when the modes were switched.
Coking Tolerance: The stack voltage and CO2 conversion were pushed far beyond the calculated values prior to the onset of coking. This capability of the fuel electrode permits higher CO2 conversion.

### Testing Results for Various Characteristics of the Fuel Electrode

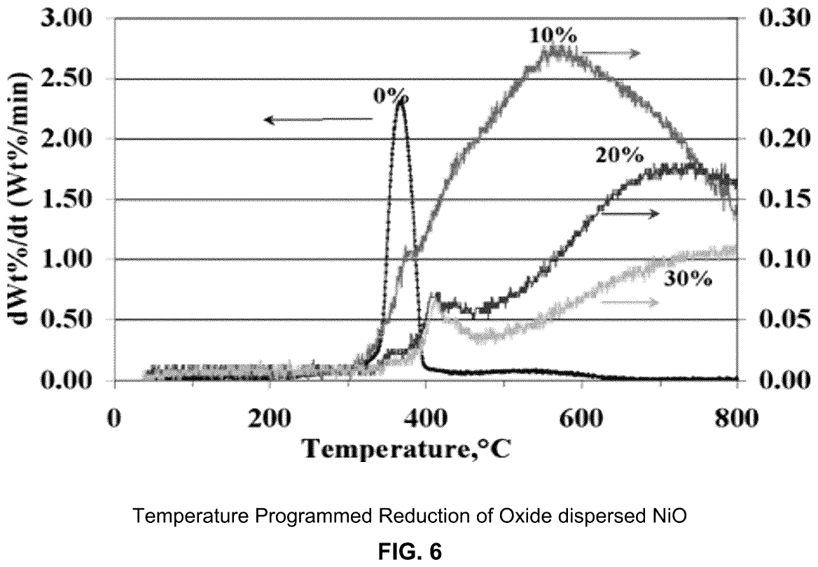

The reduction in coarsening rate was indirectly verified by performing temperature programmed reduction of NiO—MgO solid solutions containing various amounts of MgO. The results are shown in FIG. 6. FIG. 6 shows that the reduction kinetics, expressed as weight change per minute, depends on oxide content. The numbers next to each trace represent the mole % of oxide in nickel. Reduction of NiO with no oxide dispersion (indicated by 0%) has a peak rate of 2.25 wt % per minute at around 380° C., as shown on the left y-axis, while NiO containing oxide solid solution show increasing peak temperatures (500-800° C.) and decreasing reduction rates (0.275-0.1 wt % per minute, shown on the right y-axis). Thus, even a 10% oxide content reduces the reduction rate by an order of magnitude. Re-oxidation rates were not determined, and it was expected that the re-oxidation kinetics will also be largely controlled by the presence of MgO and thus the composition was expected to be redox tolerant via kinetics control.

An additional variation that included replacing 10% of Ni with Cu was also tested. Cu is known to provide coking resistance in the presence of hydrocarbon fuel and may kinetically extend the local coking limit of CO2 conversion as CO/CO2 ratio is what controls the thermodynamics of C deposition. In addition, the lower melting temperature of Cu relative to Ni may also provide better electrode sintering. It is also expected that dispersed MgO would occur in Ni—Cu grains to retard the metal grain coarsening. Cu is also known to improve the reduction kinetics of the oxide to metal.

### Fuel Electrode (or SOEC Fuel Electrode) Compostions

The following compositions, shown in Table 1 were tested for their functionality as a fuel electrode and their redox tolerance evaluated in button cells.

TABLE 1
Fuel Electrode Compositions

| Fuel Electrode Composition | Designation |
|---|---|
| 1. Ni (10 mole % MgO) - Ce(Sm)O2-x | NMCS |
| 2. Ni-10 at % Cu (10 mole % MgO) - Ce(Sm)O2-x | NCC |
| 3. Ni-(10 mole % MgO) - Zr(Y)O2 backbone | NMZ |

The fuel electrode powders were made by combining stoichiometric ratios of cation nitrates, heating the nitrate solution to an appropriate temperature to chelate the cations using glycine as the chelating agent. The produced char was calcined further at a high temperature, typically ^{˜}1,000° C., to form the NiO—CeO2 powder. In the case of MgO dispersant, only peaks corresponding to NiO and CeO2 were noted in X-ray diffraction (XRD) analysis indicating that MgO stays in solid solution with NiO.

The fuel electrode inks were screen printed on sintered ScSZ discs and sintered. Pt mesh was used as the current collector, attached using a composition identical to the fuel electrode material, and sintered at a temperature lower than the fuel electrode sintering temperature. A doped ceria layer was sintered as the barrier layer on the opposite side of the ScSZ disc. A perovskite (doped lanthanum cobalt ferrite) was sintered over the barrier side to form the oxygen electrode which also had a Pt mesh attached as the current collector. The respective layers of Pt mesh/oxygen electrode/electrolyte/fuel electrode/Pt mesh form the cell. Disc cells are typically known as the button cells. The active electrode area was 2 cm². The fuel electrode side of the button cells was sealed to a zirconia tube to form a fuel manifold where the reactant stream (CO₂, steam, or both) was introduced and the electrolysis products (CO, H₂, or both) generated.

Different processing combinations were selected to apply the fuel electrode material on zirconia electrolyte, namely sintering on a dense electrolyte, and infiltrating into a porous Ni(Mg)O— zirconia matrix. The details of fuel electrode application methods that were evaluated are shown in Table 2.

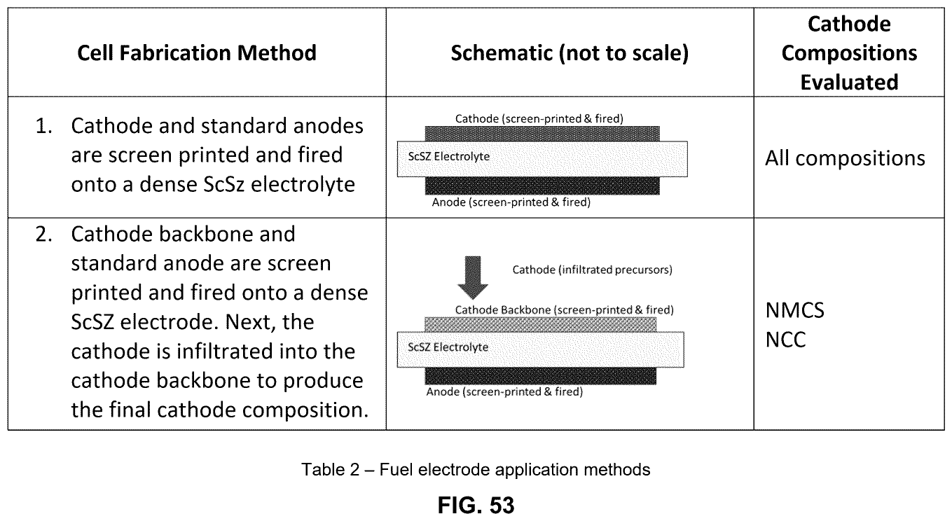

Turning now to FIG. 53, a table (i.e., Table 2) is illustrated that shows fuel electrode application methods.

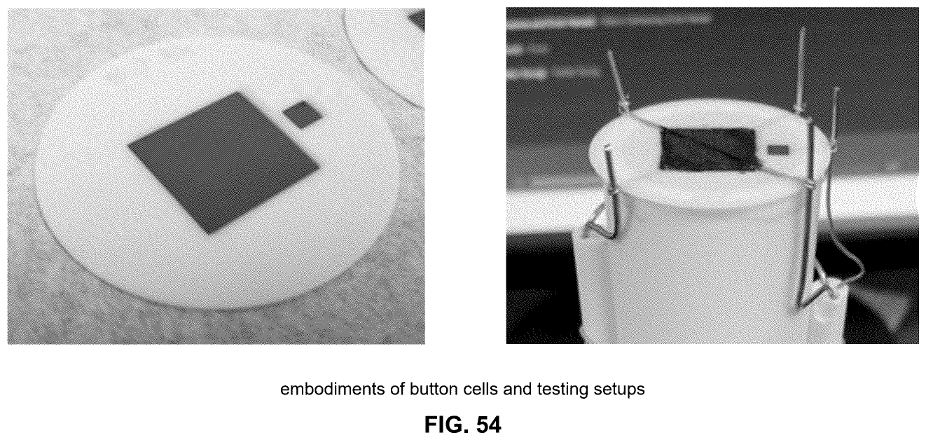

Turning now to FIG. 54, pictures are presented showing embodiments of button cells and testing setups. The picture on the left shows as-prepared button cell (oxygen electrode side) with a 2 cm² active electrode area. The picture on the right shows a button cell manifolded to a zirconia tube with current collectors.

### Test Protocol

### Redox Tolerance Testing

The button cell is heated to 800° C. with hydrogen flow to the fuel electrode manifold. The flow is maintained for sufficient time at temperature to ensure complete reduction of NiO in the fuel electrode to Ni metal phase. Dry CO₂ flow is then started, cell performance is determined via a voltage sweep, and the corresponding current is measured at each voltage. The cell voltage is maintained at 1.12 V and hydrogen is turned off for only CO₂ electrolysis. The stability of current at the constant voltage is monitored.

The applied voltage is removed such that the cell is at open circuit voltage with only dry CO₂ flowing in the fuel electrode manifold. Sufficient time is allowed to sweep out the produced CO from prior test condition and additional time for oxidation of the fuel electrode. Two oxidation time periods were tested, a 20-minute short oxidation and a 12 to 24-hour long-term oxidation.

The voltage is then applied to the cell, typically 1.12 V and the performance recovery is monitored through the measurement of current. No reducing gas is provided for the reduction of NiO. The electrochemically generated CO is the only reducing agent present in the fuel electrode chamber. Electrochemical impedance spectroscopy (EIS) is performed at various intervals to measure polarization contributions from each electrode as well as overall ohmic resistance.

Similar test protocol is also used for stack testing.

### Thermal Cycle Testing

After initial reduction of NiO in fuel electrode and performance testing, the cell is cooled in flowing dry CO₂ by turning off the test furnace. The heat up of the test furnace is done at a prescribed heating rate of 15° C./minute and once the test temperature of 800° C. is reached, a voltage is applied and the current measured. This cycle is repeated to obtain data over multiple thermal cycles. It must be noted that the fuel electrode is exposed to dry CO2 at high temperature for sufficient time to oxidize the fuel electrode. Thus, under this test protocol, the thermal cycle tests inherently include redox cycles.

Stack thermal cycle test follows a similar test sequence except due to the thermal mass of the stack and the overall volume of the present stack test stand, only a much slower heating rate of ^{˜}5° C./min is attained.

### Technical Results

“NMCS” fuel electrode compositions were compared to an alternative “NCC” composition that contains 10% copper in place of nickel for the metal phase of the composite material. NMCS designates a doped CeO2 (ceramic) and nickel (metal) cermet composite with an MgO oxide-dispersant. The NCC composition, identical to NMCS but with 10% Cu replacing Ni and specified as “NCC90” (90% Ni), showed that the screen printed fuel electrode performance and redox tolerance were comparable to NMCS and when used in an infiltrated form with NMZ backbone material outperformed infiltrated NMCS and resulted in the best redox tolerance of all cells tested.

Thermogravimetric analysis (TGA) results illustrated that the NCC90 composition reduced at a much faster rate and more completely than NMCS over 10 hours in 5% H₂/N₂ at 800° C., suggesting faster recovery from oxidation. TGA oxidation tests (using 100% CO₂ feed) also showed that the NCC90 composition oxidized more completely than NMCS over the course of many hours. However, the initial effect of oxidizing atmosphere was significantly blunted (i.e., occurred at a lower rate) for NCC90.

### Fuel Electrode Composition Variants

### Synthesis and Qualification of Compositions

Fuel electrode composition optimization included efforts focusing on the copper nickel alloying ratio and magnesium-oxide dispersion level in the metallic phase of the composite fuel electrode. The NCC fuel electrode chemical formula is shown below in the fully oxidized powder form where x is the % of Cu replacing Ni (dopant in oxide case, alloyed once reduced). NCC compositions with varying % Cu are designated as NCC[% Ni], therefore 95% Ni/5% Cu is NCC95, 20% Cu is NCC80, and so on. For initial screening and NCC composition, NCC95, NCC85, and NCC80 were selected to bracket the baseline NCC90 composition.

| | |
|---|---|
| (Ni1-xCux)0.9Mg0.1O:Sm0.2Ce0.8O1.9 | [70:30 by wt.] |
| NMCS: x = 0 NCC95: x = 0.05 | NCC90: x = 0.10 |

While the best overall performance and redox tolerance results were obtained from an NMZ-NCC infiltrated cell, bulk NCC fuel electrode cells fabricated through the traditional screen-printing method were also evaluated. Powder synthesis for each composition utilizes the glycine nitrate process (GNP). This allows for precise control of elemental ratios with a very intimate mixture that cannot be obtained by solid-state powder synthesis. All NCC powders were combustion synthesized in the same manner and calcined at the standard calcination temperature for NMCS/NCC90 to produce the desired crystal structure. The powders were then ball milled for 168 hours based on a target surface area range of 5 to 7 m2/g and past NCC milling data. All synthesized and milled powders were characterized via BET surface area and XRD analysis and determined to be within the proper surface area range and with the desired composite dual-oxide crystal structure.

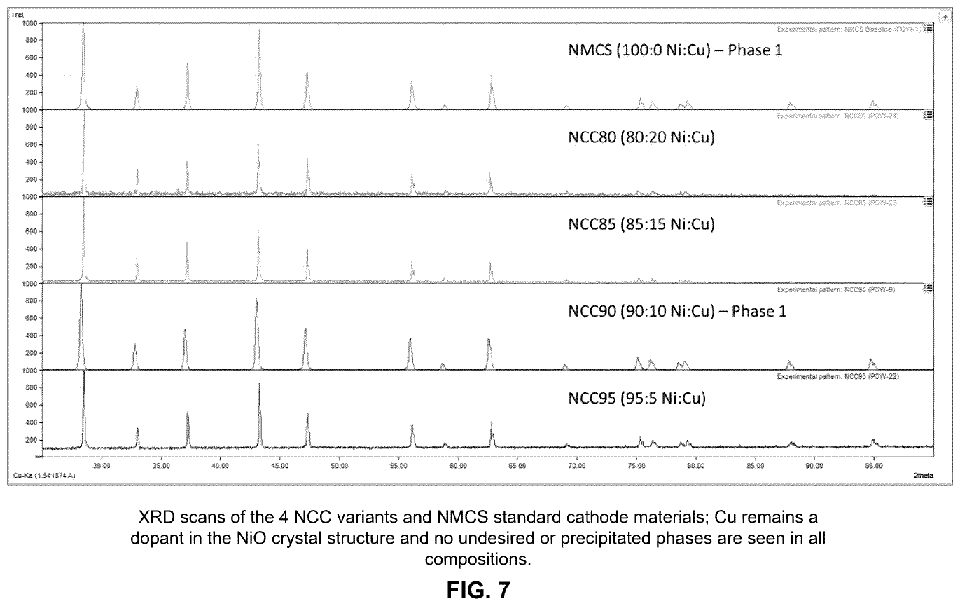

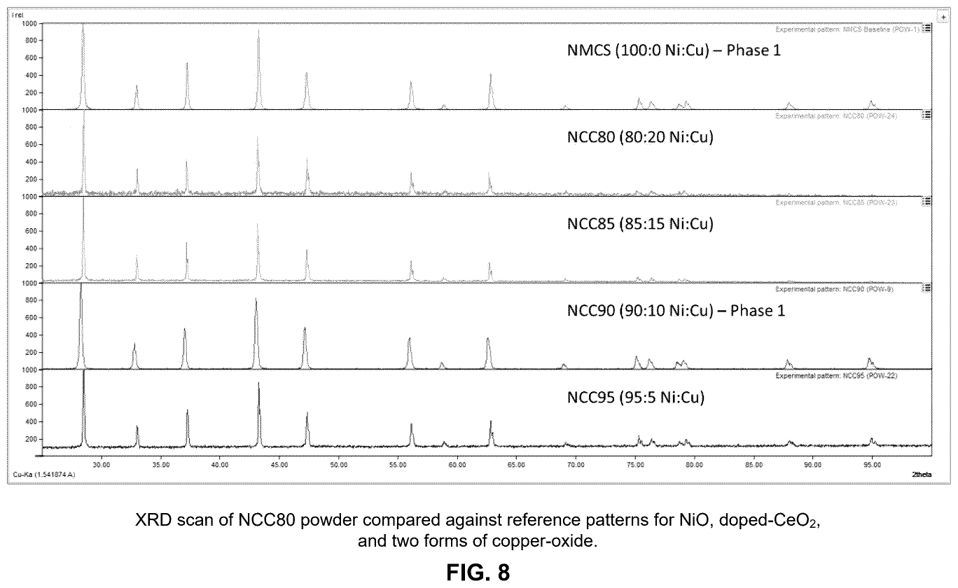

Turning now to FIGS. 7 and 8, XRD scans of fuel electrode material embodiments are shown. All synthesized NCC materials exhibited phase purity in XRD analysis. XRD analysis of the NCC variants and the NMCS baseline material indicates that no significant unexpected or impurity phases are present, and NMCS, and the NCC variants were comprised of nearly identical material compositions. FIG. 7 breaks down the XRD analysis of NCC80, illustrating that the identified peaks come from separate NiO and doped CeO₂ phases, as intended. Even though NCC80 contains significant levels of copper, no independent copper-oxide phases are present in the sample. This indicates that the combustion synthesis method yields complete doping of the nickel-oxide atomic structure with homogeneous distribution of copper atoms, which when reduced results in a well-mixed copper-nickel alloy metal.

### TGA Testing of Fuel Electrode Compositions

TGA was used as the primary tool for testing specific compositions for the fuel electrode material and the backbone for the two fabrication options. Table 3 lists the sequence of testing for two separate samples of each NCC composition (i.e., for 5, 15, and 20% Cu addition fuel electrode variants). Sample #1 for each composition is exposed to initial reduction using forming gas (5% H₂ in N₂) to represent initial reduction of fuel electrode material during start-up of a stack. The sample is then sent through a full redox cycle consisting of oxidation using 100% CO₂ feed followed by H₂ re-reduction. A final CO₂ oxidation run to compare CO₂ oxidation rates between cycles completes the sequence. The testing sequence for sample #2 of each composition is identical to sample #1, except that the 2^{nd} reduction is done with 5% CO balance CO₂ gas to simulate reduction recovery from self-generated CO reducing atmosphere (represents returning operational load to a stack with 100% CO₂ feed). The CO reduction recovery samples were submitted various compositions of interest. However, the sample #1 sequence is identical to that used for the baseline NMCS composition and the first NCC variant “NCC90” (90% Ni/10% Cu) and those comparisons are included here.

TABLE 1
Phase II TGA testing sequence for NCC80, NCC85, and NCC95

| Run # | Sample #1 | Sample #2 |
|---|---|---|
| 1 | H₂ reduction | H₂ reduction |
| 2 | CO₂ oxidation | CO₂ oxidation |
| 3 | H₂ reduction | CO reduction |
| 4 | CO₂ oxidation | CO₂ oxidation |

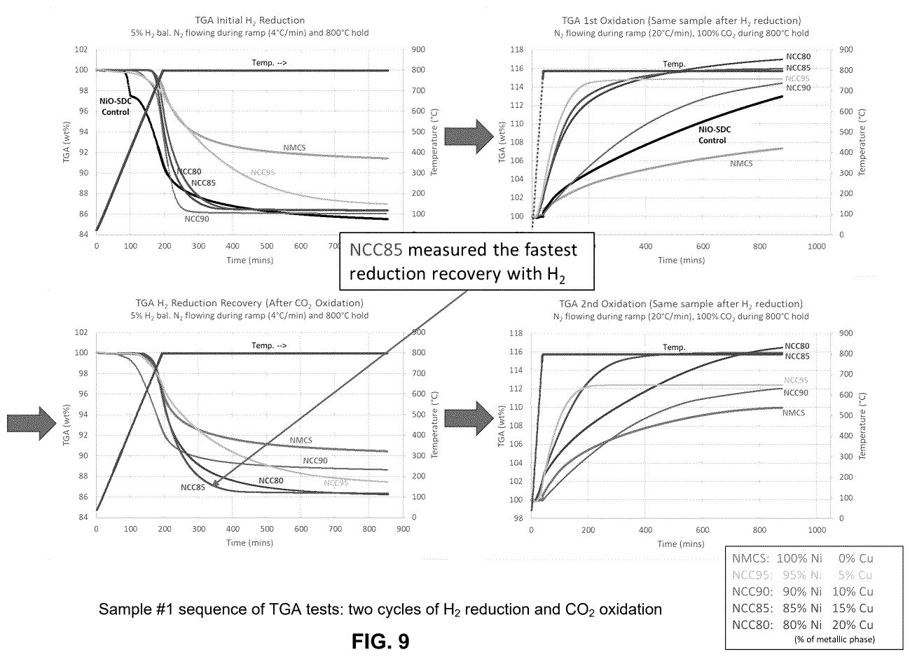

When comparing the various NCC fuel electrode materials (FIG. 8) there is a general trend of higher % Cu resulting in faster reduction and oxidation kinetics. While this trend is not always followed by the NCC variants, the comparison to NMCS baseline fuel electrode composition makes clear that the addition of Cu has a significant effect on redox kinetics. Faster reduction kinetics is desired for reduction recovery of a cell or stack that has been exposed to oxidizing atmosphere. Faster oxidation kinetics was previously believed to result in damage to the fuel electrode's microstructure and lower performance, however the fuel electrode composition of NCC85 showed excellent redox tolerance while also exhibiting fast oxidation kinetics. NCC80 may be expected to measure the fastest reduction kinetics due to the high % Cu but NCC85 showed the fastest re-reduction, which translates to superior recovery after CO2 oxidation as shown in FIG. 9.

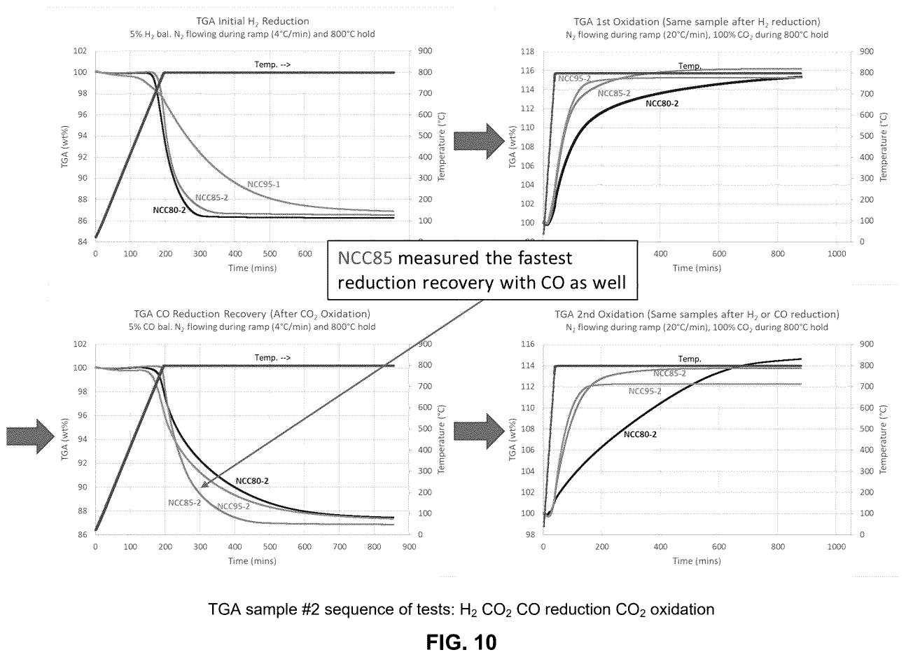

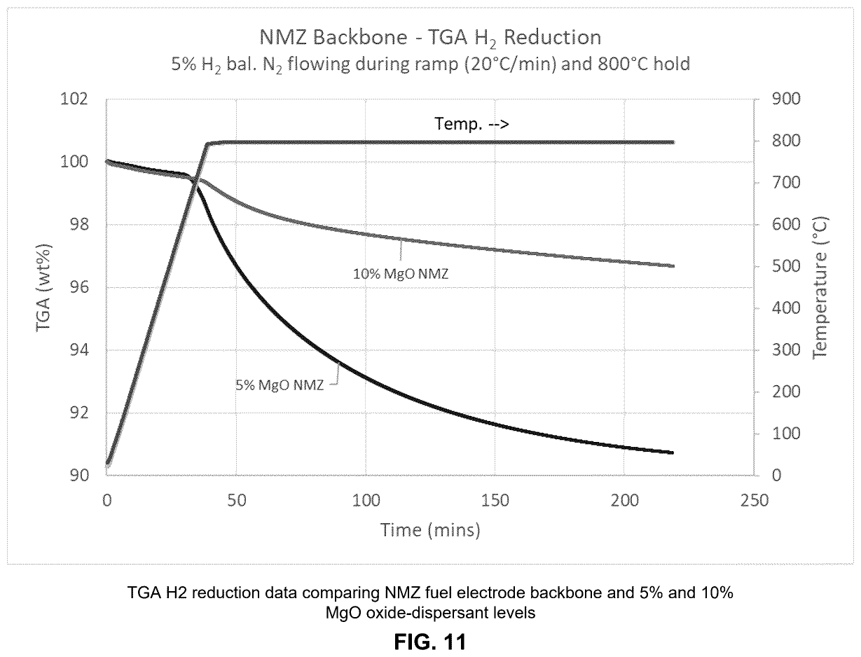

The sample #2 sequence of TGA tests is shown in FIG. 10, with special attention paid to the 3^{rd} test measuring CO reduction recovery rate which also showed the fastest reduction kinetics for the NCC85 composition. The reduction recovery for NCC85 is compared between H₂ and CO gases, showing that 5% CO is as effective as 5% H₂ at reducing the NCC85 fuel electrode at a relatively high rate. This close comparison between CO and H₂ is consistent with the other NCC variants and confirms that recovery from oxidation due only to stack operation and self-generated CO should be similar to recovery from a supplied reducing atmosphere.

### Backbone Matrix Composition

Because of the potential advantage of an infiltrated NCC85 fuel electrode into the NMZ matrix, comparing the redox kinetics of variations of NMZ is of interest. An NMZ fuel electrode backbone variant with 5% MgO oxide-dispersant was tested in button cells and the results suggest faster reduction kinetics.

Results of TGA comparing 5 and 10% MgO variations of NMZ are shown in FIG. 11, and as expected the 5% MgO NMZ backbone shows a much faster rate of reduction. 10% MgO baseline was previously proven to drastically slow the reduction kinetics of Ni based fuel electrodes, so it follows that less MgO should allow for faster reduction recovery. The goal is to recover cell performance as quickly as possible while still diminishing the rate of reduction to prevent microstructural damage and impart better redox tolerance.

### Alternative Current Collector

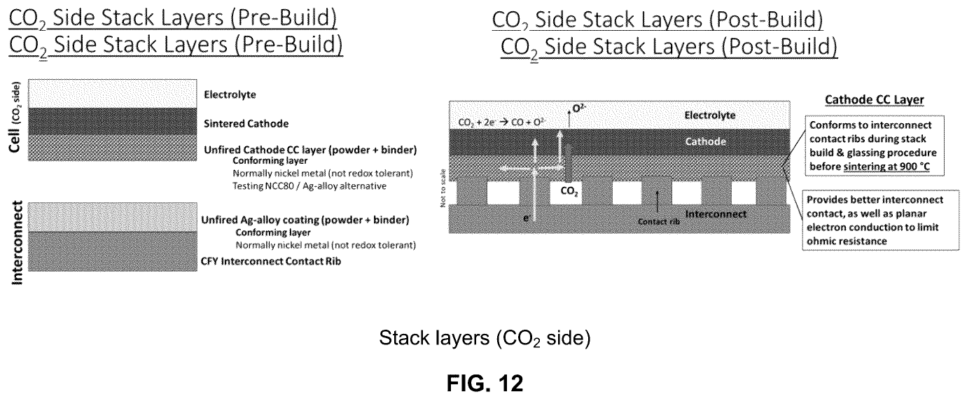

In one embodiment, a current collector is complementary to a redox tolerant fuel electrode composition. The current collecting (CC) layer in a button cell or a stack refers to the layer on, or as part of an electrode of the cell and acts as an electron conductor. The current collector connects the cell to a power supply in electrolysis operations or an electrical load in fuel cell operation through a conductive wire in a button cell or to the adjacent interconnect in a stack. The CC layer needs to provide conformal contact to the interconnect contact ribs in a stack, or the Pt-mesh in a button cell test. The CC material also provides lateral current distribution to shorten the conduction path, thereby reducing ohmic resistance contributions. These concepts are illustrated in FIG. 12, which shows the pre-build and post-build considerations of a stack. The sinterability of the CC layer at the stack sealing temperature of 900° C. is important for the CC layer to form a well-connected sheet that is sufficiently bonded to the fuel electrode at this relatively low temperature.

In an alternative embodiment, the current collector may include a 50/50 volume mix of Ag—Pd (70/30 by wt.) alloy and NCC80 cermet. In another embodiment the mix may contain Ag and NCC80 cermet. The Ag or Ag—Pd may range from 0 to 50% volume percent. Other suitable metal component may also be mixed with NCC80 or other NCC variants. The NCC80 fuel electrode material was mixed with Ag—Pd to improve both redox and thermal cycling tolerances. The NCC80 composition was selected due to the high Cu %, which is known from SEM characterization to increase relative sinterability at a given temperature, resulting in a more conductive layer. The benefit of the interconnected Ag or Ag—Pd alloy is that it cannot be oxidized; therefore, after partial or full oxidation of the fuel electrode material the current collector can immediately function as fuel electrode along with ceria in the primary fuel electrode layer. Thus, the electronic conducting Ag or Ag—Pd in the current collection layer and the mixed conducting ceria in the fuel electrode layer provide the electrochemical functionality to electrolyze CO₂ and the produced CO reduces the NiO in the electrode and the current collector.

### Test Results

### Redox Tolerance

### Electrochemical Cell Testing

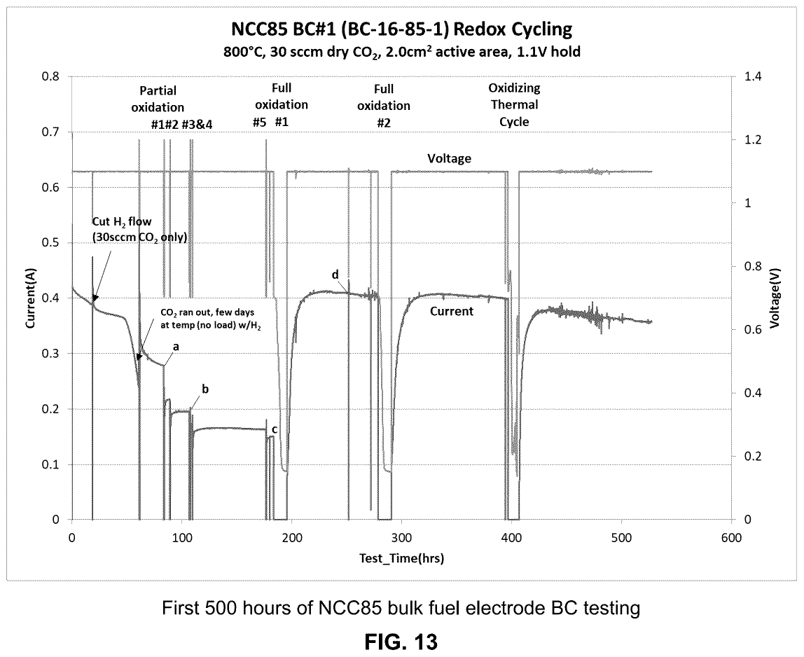

In one embodiment, the NCC85 button cell was tested with the first 500 hours of bulk fuel electrode BC testing shown in FIG. 13.

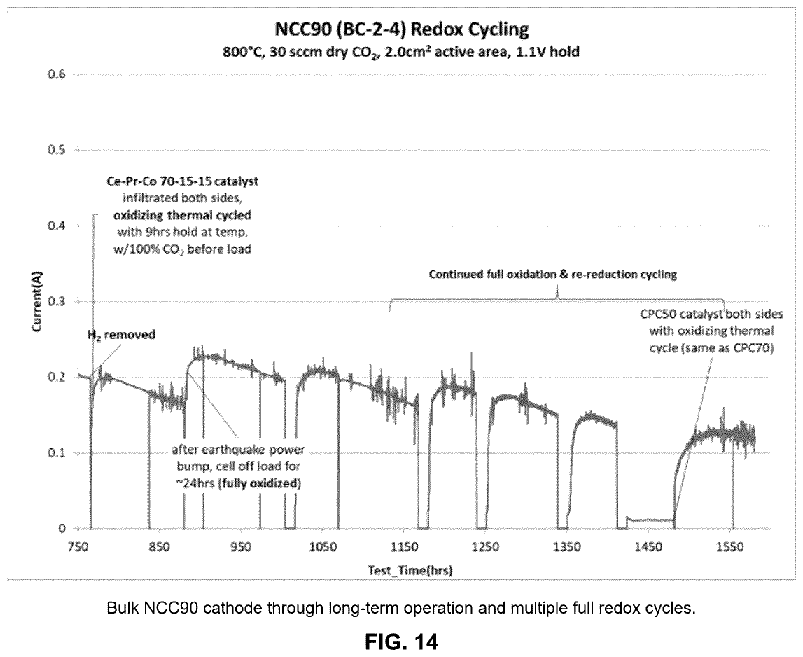

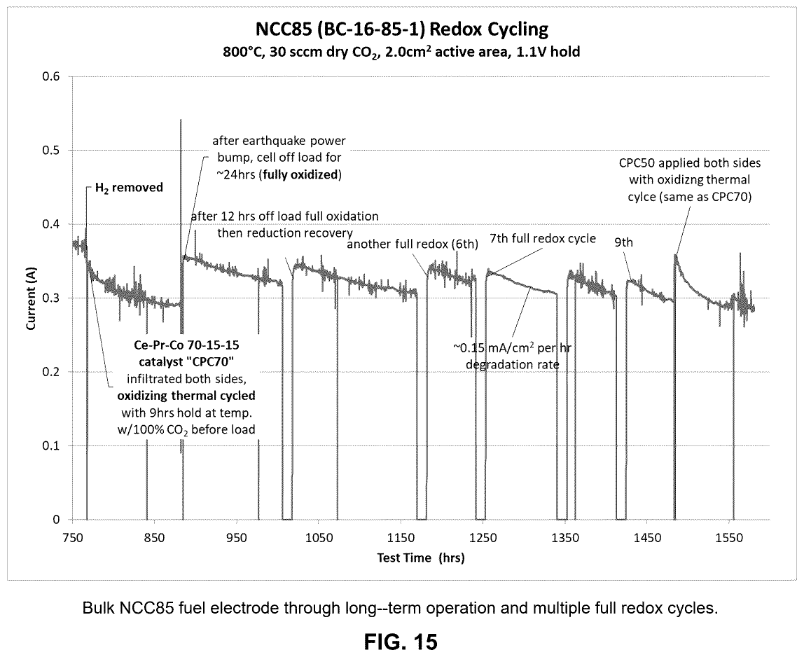

A catalyst formulation with a combination of Ce, Pr, and Co nitrates was infiltrated into the fuel electrode after the cell was cooled. A designation CPCn was used to indicate that Ce atom content was n % and Pr and Co content were (1−n %)/2 each. For example, CPC70 would indicate a metal ratio of 70:15:15 of Ce, Pr, and Co. FIG. 14 and FIG. 15 show the effects of added CPC70 and CPC50 catalysts, long-term operation from 750 to 1550 hours of test time, and multiple full oxidation cycles. The remarkable performance recovery from a full oxidation cycle shows redox tolerance and that redox cycling actually helps to limit degradation from long-term operation. NCC85 measured more stable performance over this time period, with the cell current remaining largely above 0.3 A.

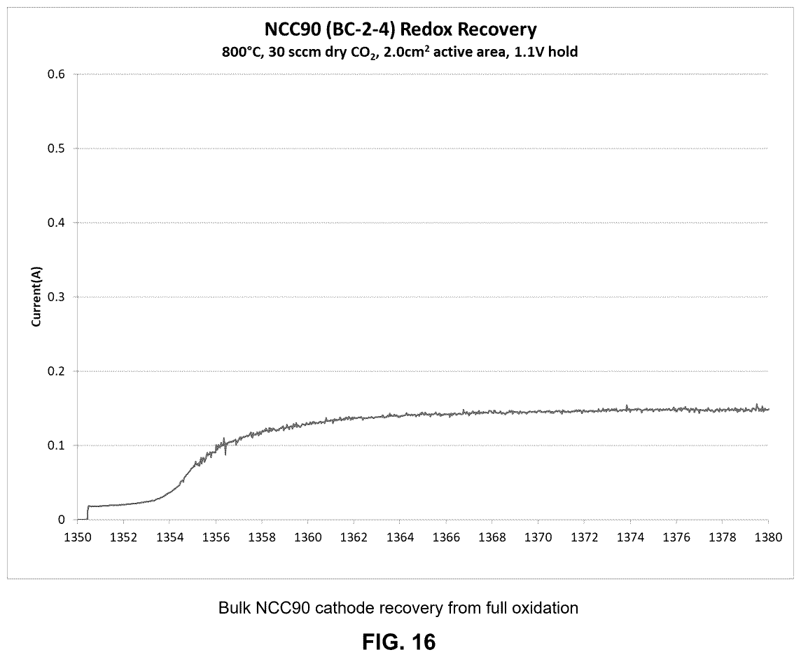

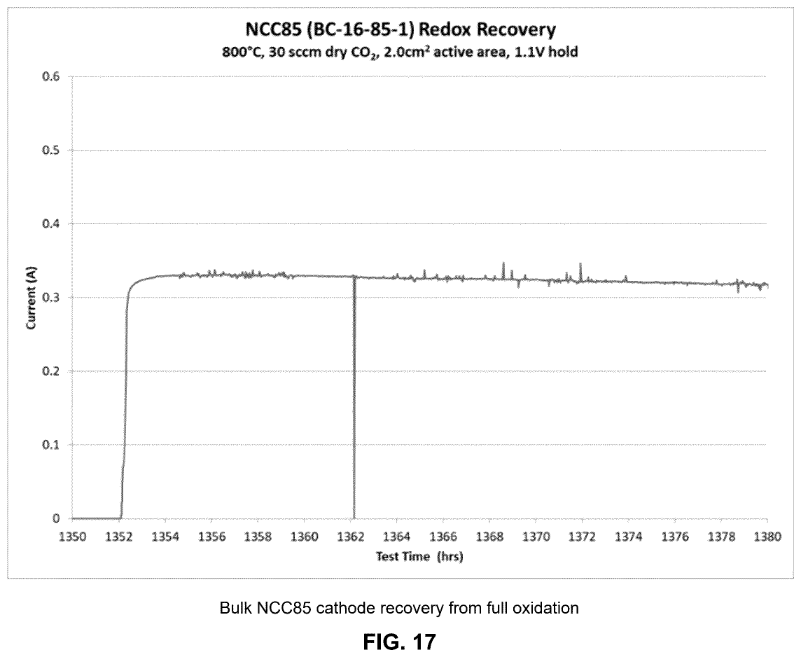

Another measured advantage to NCC85 over NCC90 is the time to recover performance after a full oxidation and reduction recovery cycle. FIG. 16 and FIG. 17 illustrate that NCC90 took ^{˜}10 hours to recovery whereas at the same point (with same test history, catalysts applied) NCC85 recovered in less than an hour.

Table 4 lists the final performance values for all four NCC variants as bulk screen-printed fuel electrodes. While the current density was lower for NCC85 than NCC95 and 80, the degradation rate measured (measured for comparable data, under 30 sccm CO2 condition) is much lower than the other cells.

TABLE 4
Final current density and degradation rate
for NCC variant bulk fuel electrode BCs.

| | Final Performance | |
|---|---|---|
| | @ 1600- | Deg. Rate |
| Cathode | 1700 hrs with 30 | (−mA/cm² |
| Composition | sccm dry CO₂, 1.1 V | per 1000 hrs) |
| NCC95 | 0.17 A/cm² | 94 |
| NCC90 | 0.06 A/cm² | 62 |
| NCC85 | 0.14 A/cm² | 7 |
| NCC80 | 0.16 A/cm² | 53 |

Due primarily to the superior performance stability, NCC85 was determined to be the better fuel electrode composition of those tested and was selected for infiltrated fuel electrode testing.

### Infiltrated Electrode Cells

With the NCC85 composition selected from the bulk NCC fuel electrode testing, the next step was to test NCC85 as an infiltrated material into the NMZ backbone. However, to analyze the effect of infiltrated NCC85 the NMZ backbone was tested without infiltration (baseline NMZ test BC-023-1) to compare to two different levels of NCC85 fuel electrode loading (BC-023-3 & 5). The NCC85 precursor solution (aqueous mix of nitrates with a surfactant) was repeatedly infiltrated into the NMZ backbone structure and calcined at 600° C. to decompose the nitrates to the desired doped Ni(Cu)O/CeO2 oxides before subsequent infiltration. The two levels of infiltration loading selected were 6 cycles and 12 cycles. Six cycles were selected to evaluate half-loading relative to the 12 cycle-baseline. The current collector material selected for these initial NMZ trials was NCC80 fired at 1150° C. (applied after infiltrations/calcinations). Lastly, each cell was infiltrated on both sides with the “CPC50” catalyst instead of the standard PrCo catalyst prior to loading for tests. A summary of these cells is shown in Table 5.

TABLE 5
Summary of initial NMZ BC testing trial

| BC# | Cathode Material(s) | Cathode CC | Results Summary |
|---|---|---|---|
| BC-023-1 | NMZ backbone only | NCC80 1150° C. | Worst (NCC |
| | | | infil. necessary) |
| BC-023-3 | NMZ with 6x NCC85 | NCC80 1150° C. | Best → down |
| | infiltrations | | selected |
| BC-023-5 | NMZ with 12x NCC85 | NCC80 1150° C. | Poor (overloaded |
| | infiltrations | | NCC85) |

To emphasize the benefit of the infiltrated NCC85 fuel electrode, Table 6 compares the EIS results of the NMZ cells with no infiltration and 6 infiltrations of NCC85. The starting ohmic resistance is not only lower for the infiltrated cell but it exhibits good stability and remains low through short-term operational duration and 5 partial redox cycles. Most notable however, is the far superior and much more stable fuel electrode PR. Theoretically, this is due to the high surface area (and hence increased triple phase boundary area (TPB)) and catalytic activity of the infiltrated NCC85 fuel electrode material, which after infiltration and sintering produces very fine particles of Ni/Cu metal and doped CeO2 oxide. After full oxidation and during reduction recovery the ohmic resistance of the infiltrated cell drops significantly faster than the cell with NMZ alone. The polarization resistance also recovers much more for the infiltrated cell after full redox cycles.

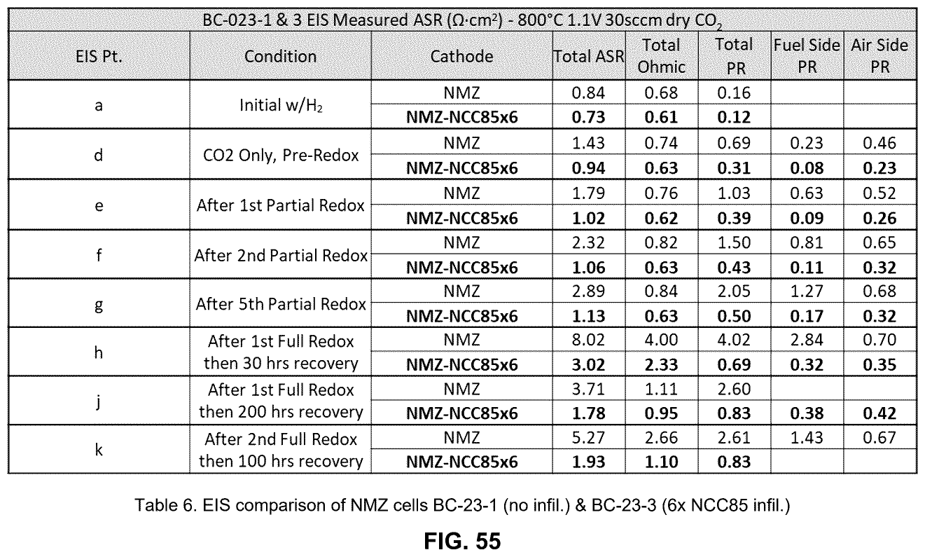

Turning now to FIG. 55, a table (i.e. Table 6) is presented that shows an EIS comparison of NMZ cells BC-23-1 (no infil.) & BC-23-3 (6×NCC85 infil.).

With 6 infiltrations of NCC fuel electrode providing so much benefit, increased number of infiltrations was tested.

Infiltrated Cells with Alternative Current Collector

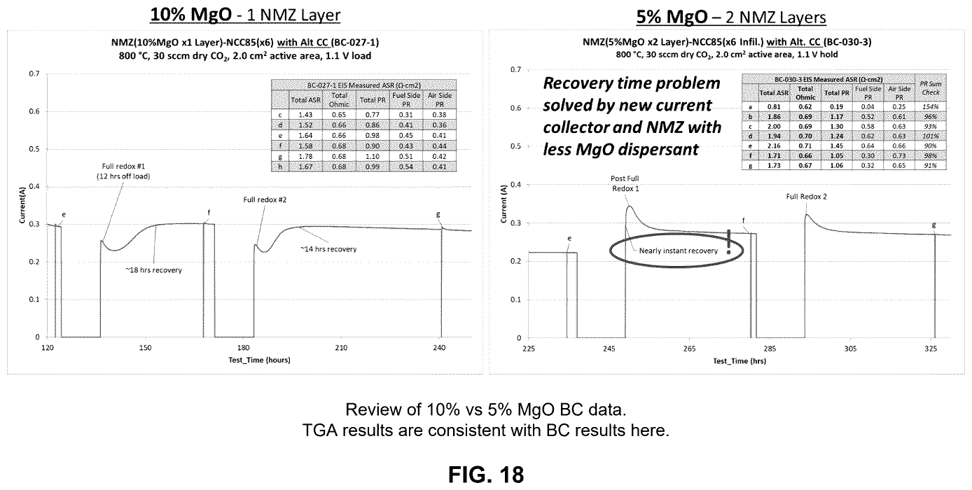

Two MgO contents in the backbone NMZ layer with infiltrated NCC85 electrode and Ag—Pd/NCC80 alternative current collector were evaluated in button cells. The key observation was the very rapid recovery of the 5% MgO backbone after complete oxidation as shown in FIG. 18. This combination is selected as the baseline for infiltrated electrode.

### Thermal Cycling

### Infiltrated Fuel Electrode—Thermal Cycling

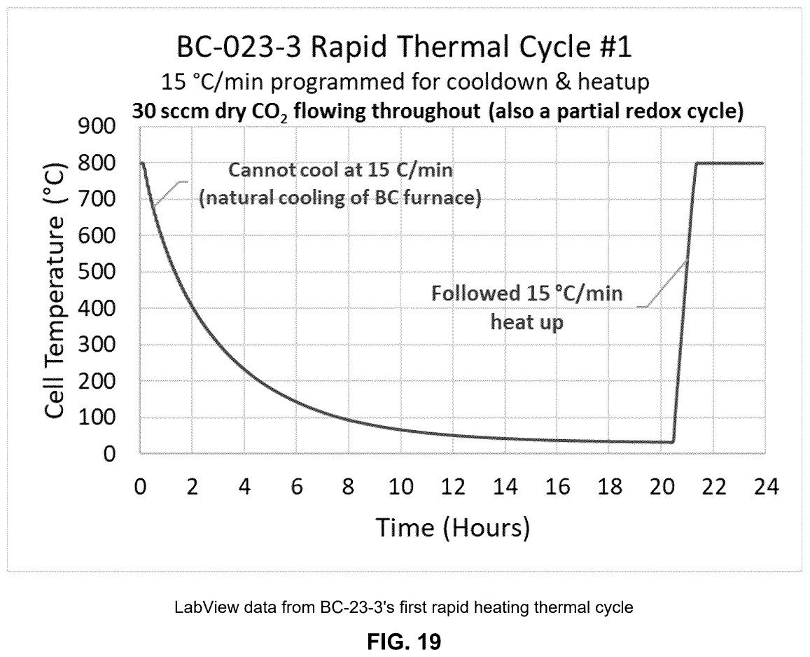

Button cells were thermal cycled up to 70 times, with at least 5 thermal cycles programmed with a relatively rapid heat up of 15° C./min to 800° C. Twelve heating cycles using 15° C./min heat up were selected to further stress test and verify stability, with the 1.1 V load removed simultaneously with cooldown start and reapplied when the cells reached 800° C. again. An example of the thermal cycling scheme is shown in FIG. 19 which illustrates why the rapid portion is on heat up, not cooldown. While 15° C./min was programmed for the cooldown as well, the BC furnace cools much slower and the time to drop from 800° C. to near RT can take about 20 hours. The programmed heat up was followed, and all cells discussed here were verified to heat up at the desired 15° C./min rate. By using only dry CO2 flow during thermal cycling each thermal cycle is also a partial redox cycle due to the oxidation taking placed between ^{˜}600 and 800° C. during cooling and heating. BC testing utilizes the same glass-ceramic seal as stacks (to form a hermetic seal on the zirconia test tube), therefore thermal cycling of BCs is representative of thermal cycling in a stack regarding cell and seal integrity. A difference between stack and BC thermal cycling is that BC testing does not include the interconnect material or an interconnect seal interface. The data discussed here indicates that the cell and the seal have no problem with rapid 15° C./min heating cycles, providing confidence that the cells and seals in a stack will handle rapid heating cycles well.

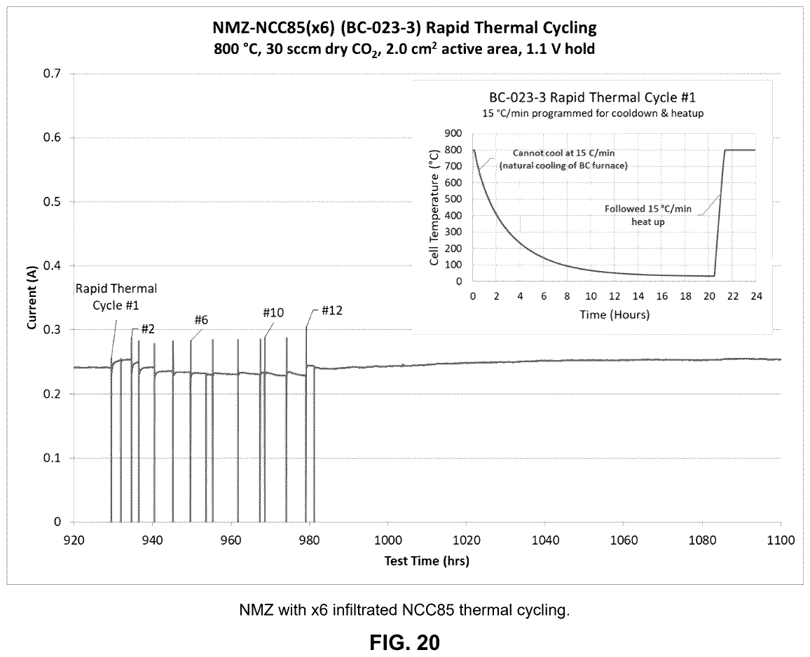

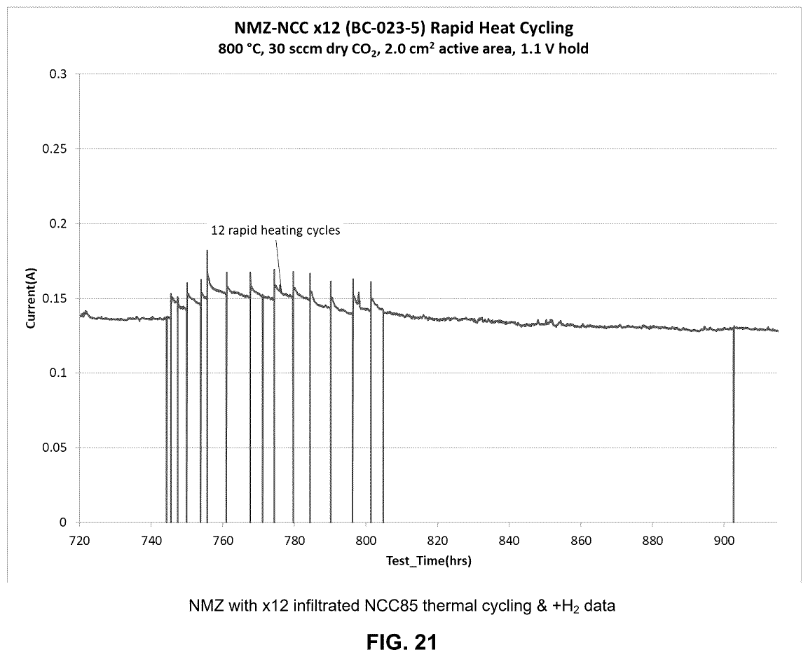

NMZ with 6 infiltrations of NCC85 fuel electrode showed much better stability through thermal cycling as shown in FIG. 20. This cell also showed a slight bump in performance after the 1st thermal cycle, which appears to be due to a drop in ohmic resistance which was observed in all three of these NMZ cells. For both the 6× and 12× (FIG. 21) infiltrated cells the drop in ohmic appeared to be permanent, evidenced by comparing EIS points just before thermal cycling to EIS taken after 12 cycles and ^{˜}100 hr hold with 100% CO₂ feed just before H₂ addition (at ^{˜}1100 hours test time). EIS also measured an increase in polarization resistance through thermal cycling, which could also be due to operational degradation. However, the 6× infiltrated cell did measure some recovery of PR during the post-12 cycles hold (points p and q). H2 addition at the very end of testing BC-023-3 measured the expected drop in cell ASR (although current dropped as well, due to Nernst potential differences), which was reflected in both ohmic and PR drops. NMZ with 12 infiltrations of NCC85 (FIG. 21) shows similar stability through the dozen rapid thermal cycles, albeit with overall lower performance. At the end of testing the ×12 cell, only a small amount (<1 sccm) of H2 was added and allowed to sit for a few hours before increasing H₂ to 17 sccm. EIS data reveals a very large drop in fuel electrode PR from the small amount of H₂, which got even better with the higher amount of H₂. Ohmic resistance also benefited from the presence of an increase in H₂ flow for this cell.

The three NMZ cells discussed to this point (BC-023-1, -3, and -5) all had the same NCC80 1150° C. current collecting material. The thermal cycling data shown verifies that the NMZ backbone, infiltrated NCC85 fuel electrode, and NCC80 fuel electrode acting as the current collector in this case all exhibit excellent tolerance to thermal cycling with rapid heat up.

### Alternative Current Collector BCs—Thermal Cycling

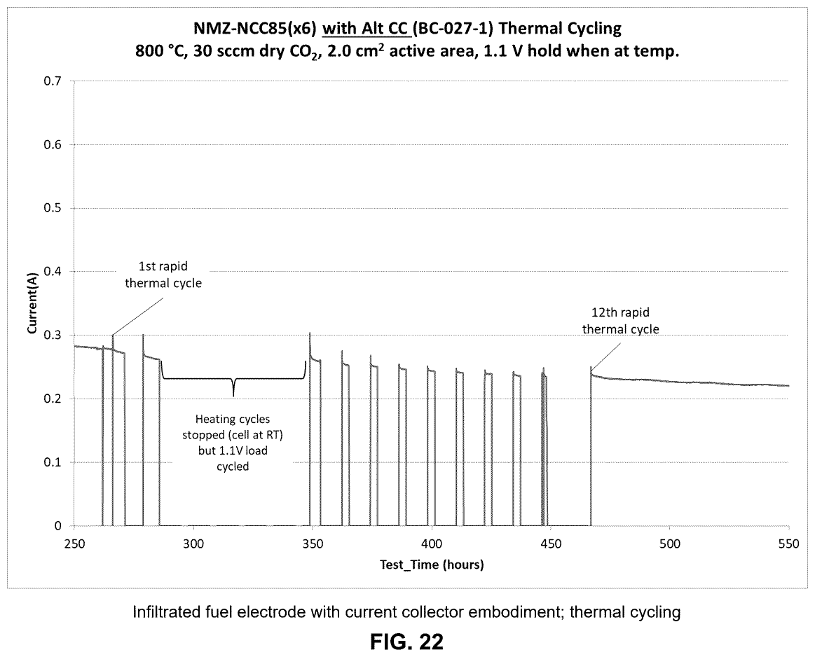

The thermal cycling regime for each cell is shown in FIG. 22. The infiltrated cell showed no ohmic degradation throughout all 12 rapid heating cycles, with excellent adhesion and stability of the alternative CC layer to the NMZ-NCC85 electrode.

BC-30-3 is made from two layers of the NMZ fuel electrode backbone with six infiltrations of the NCC85 fuel electrode material, and the Ag-Alloy/NCC80 current collecting layer. BC-30-3 was tested further and was used for 62 additional rapid thermal cycles (72 total).

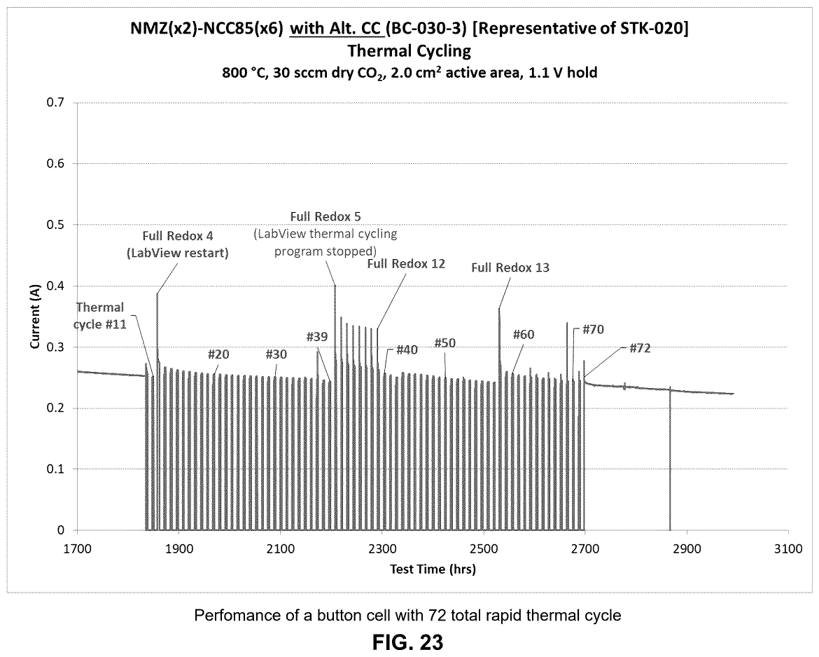

The full thermal cycle data set is shown in FIG. 23, along with a table comparing the EIS measured before and after the 62 additional thermal cycles.

A 10-cell stack was built with the fuel electrode. The stack footprint was 13 cm×13 cm, and each cell had an active electrode area of 110 cm². Stacks use interconnects which are coated on the oxygen electrode side with a spinel layer to reduce chromium transport to the electrode which is a known poison for electrochemical activity. The primary focus of the stack test was to evaluate its redox and thermal cycle capabilities of the stack for dry CO₂ electrolysis and compare them to those of button cells.

The fuel electrode materials used for the stack followed the sequence of two printed/fired layers of NMZ backbone with six infiltrations of NCC85 fuel electrode material, followed by a printed Ag-alloy and NCC80 fuel electrode mixture current collector layer (left green/unfired for stack build).

The interconnects used for the stack were coated with Ag-alloy (same as used in fuel electrode current collector) on both the air/O2 and fuel/CO2 sides. The air side normally utilizes the same Ag-alloy coating, whereas the fuel side is normally coated with a nickel metal layer. A layer of nickel felt that is normally included to assist with cell to interconnect contact on the fuel side was excluded here, since it would also not be redox tolerant. This means that the cell to interconnect contact is more dependent on the unfired (conforming) cell current collector layer and the alloy coating on the interconnect (also left unfired prior to stack build).

### CO₂ Electrolysis & Redox Cycle Testing

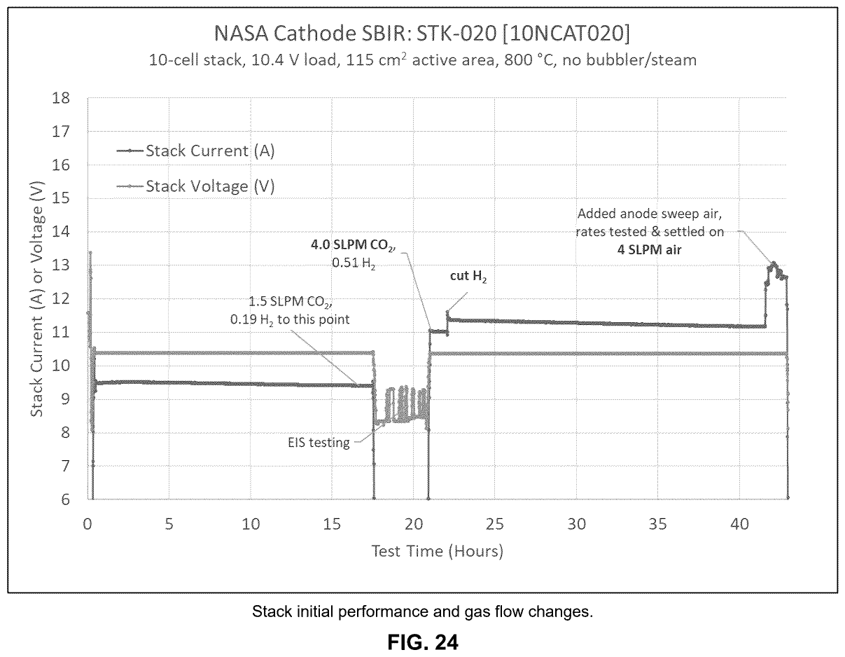

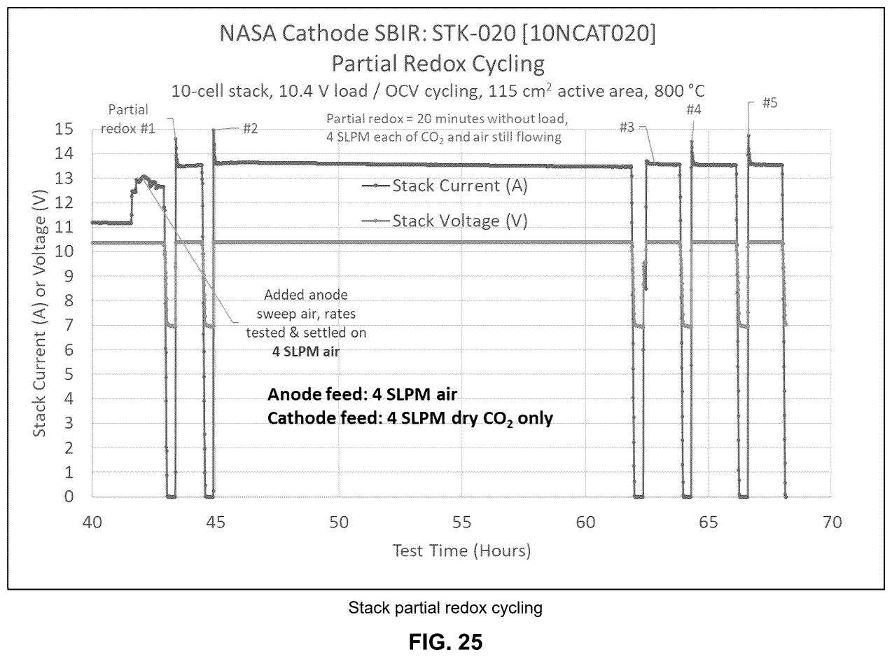

After heating the stack to 800° C. with H2/N₂ flowing on the fuel electrode side and no flow on the anode side (stagnant air) the stack remained at temperature for about 12 hours before testing started. In one embodiment, a 1.5 SLPM CO2 and 0.19 SLPM H2 in the fuel electrode feed was selected for initial testing. The stack operating voltage was selected to be 10.4 V (1.04 V avg. cell) to limit the risk of coking and was kept constant throughout the stack testing (excluding open circuit voltage (OCV)/oxidation cycles and current-voltage (IV) sweeps). After sweeping the stack up from OCV to 10.4 V for the first time, the current stabilized at 9.5 A. Allowing the stack to hold at these operating conditions overnight showed relatively good stability of the stack performance, with the current dropping only 0.08 A or about 0.8% in those initial 15 hours (FIG. 24). The stacks were then tested for partial redox cycling (FIG. 25).

After completing partial redox cycling, the stack was subjected to “full” redox cycling by removing the electrical load for ^{˜}20 hours to allow for near complete oxidation of Ni(Cu) in the fuel electrode materials. This fuel electrode oxidation is represented by a drop in the OCV measurement from 7.1V to 1.5 V, at which point it bottoms out signifying complete oxidation. The complete oxidation took 5 hours for the 1^{st} full redox cycle, then about 4 hours for the 2^{nd} full oxidation, however the stack was left off load overnight in each case to ensure complete oxidation. Once the 10.4 V load was applied after the 1^{st} full oxidation the stack current instantly reached 10 A, then only 1.6 hours later reached peak recovery of 19.6 A. The instant performance is partly owed to the presence of doped ceria in the fuel electrode that functions as mixed conducting electrode to restart CO₂ electrolysis to produce reducing CO gas. The self-generated CO proceeds to reduce the Ni(Cu)O back to Ni/Cu metal enabling recovery of active sites for further CO₂ electrolysis.

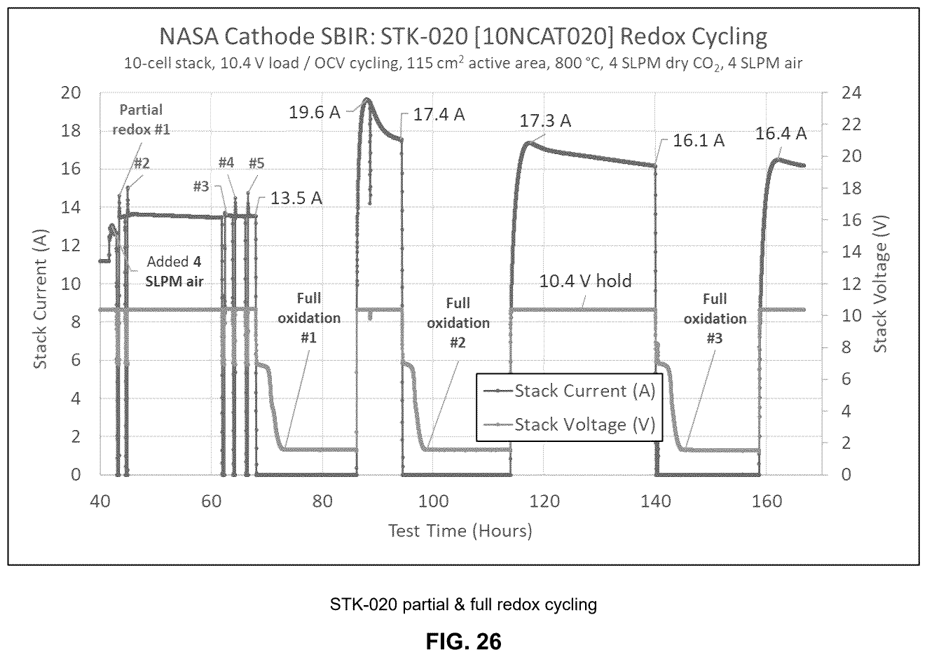

Based on BC testing, full redox cycling is known to significantly drop the polarization resistance of the fuel electrode but may also drop the ohmic resistance; both appear to have occurred in this case leading to a large boost in performance from 13.5 A to 17.4 A after peak recovery and relative stabilization. The stack was cycled two more times through full oxidation and reduction recovery as shown in FIG. 26. The second recovery peaked just under the stack performance prior to the 2nd oxidation (from 17.4 to 17.3 A). After overnight operation it dropped to 16.1 A, the 3rd full redox cycle was conducted resulting in 16.4 A peak recovery. The 5 partial redox cycles and 3 full redox cycles complete a full set of redox cycling, matching the standard used for button cell testing and achieving the redox cycling.

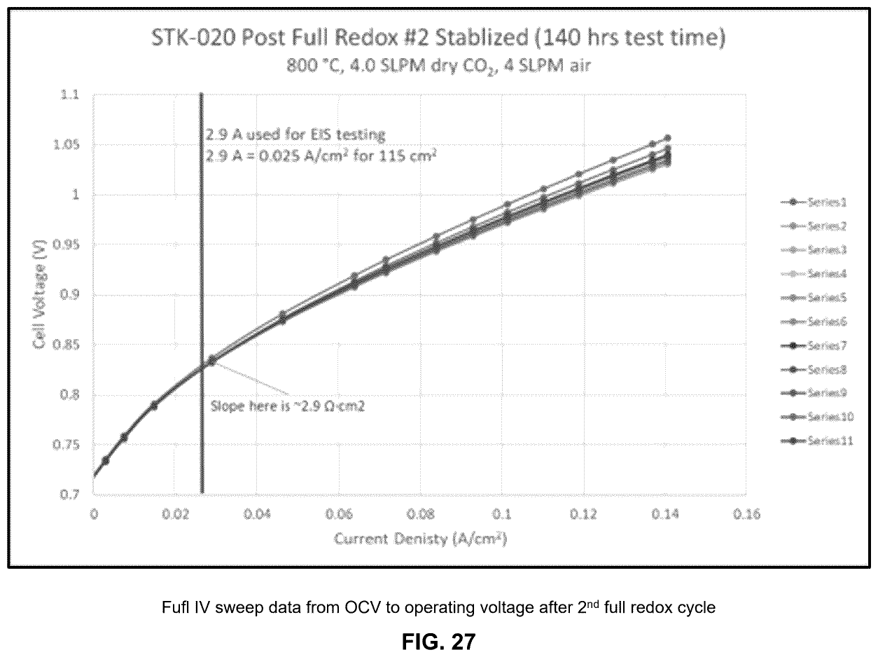

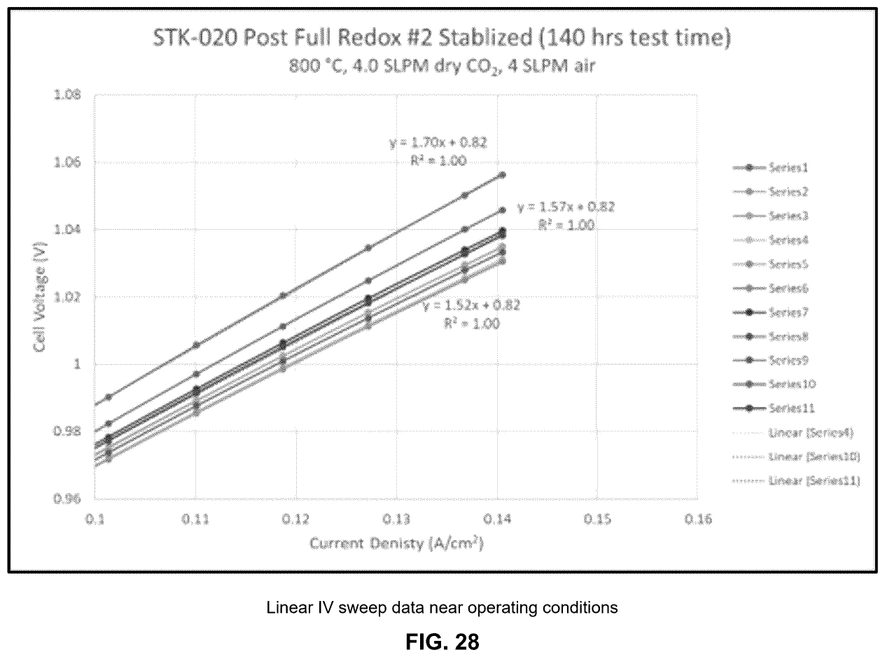

IV sweeps were used to measure stack and individual cell ASRs at various points throughout testing where only the linear regime near the operating voltage of the IV data was used for linear fits as shown in FIGS. 27 and 28. The IV sweep results are compiled in Table 7, showing the stack (avg. cell), best, and worst cell ASRs. After the 1st full redox cycle, the best cell ASR measured only 1.2 Ω·cm² with the worst cell at 1.4 Ω·cm². After reaching relative stabilization the best and worst cell ASRs had increased to 1.4 and 1.6 Ω·cm², respectively. The phenomenon of peak performance followed by a drop to more stable performance is considered to be due to a large initial increase of electrocatalyst surface area (and TPB) from the oxidation/reduction cycle that is followed by coarsening of the highly active material to lower surface area and therefore higher polarization resistance. The instant stack ASR after full oxidation was measured at 114 hours test time to be 3.4 Ω·cm², which is quite remarkable given that the fuel electrode has had practically no time to self-reduce at this point. Overnight stabilization after the 2nd full redox resulted in a stack ASR of 1.6 Ω·cm², approximately half of the instant post-oxidation resistance.

TABLE 7
IV sweep date through stack STK-20's gas changes and redox cycling.

| Gas Flows | | | | | | | |
|---|---|---|---|---|---|---|---|
| cathode/ | Test | | Stack | Stack | ASR (Ω · cm²) | | |
| anode feed | Time | | Voltage | Current | | Best | Worst |
| (SLPM) | (hour) | Stack Condition | (V) | (A) | Stack | Cell | Cell |
| 1.5 CO₂, 0.19 | 0 | CO₂ + H₂, lower flows | 10.4 | 9.5 | 1.76 | 1.69 | 1.91 |
| H₂/no air | | | | | | | |
| 4.0 CO₂, 0.51 | 21 | CO₂ + H₂, higher | 10.4 | 11.1 | 1.57 | 1.47 | 1.72 |
| H₂/no air | | flows | | | | | |
| 4.0 dry CO₂/4 | 43 | Dry CO₂ only, air | 10.4 | 12.6 | 1.92 | 1.82 | 2.06 |
| SLPM air | | flow on, pre-redox | | | | | |
| | 44 | After 1st partial | 10.4 | 13.5 | 1.80 | 1.70 | 1.90 |
| | | redox | | | | | |
| | 62 | After 2nd partial | 10.4 | 13.5 | 1.85 | 1.75 | 1.98 |
| | | redox & overnight | | | | | |
| | | hold | | | | | |
| | 68 | After 5th partial | 10.4 | 13.5 | 1.88 | 1.84 | 2.04 |
| | | redox | | | | | |
| | 89 | 1st full redox, peak | 10.4 | 19.3 | 1.26 | 1.18 | 1.39 |
| | | performance | | | | | |
| | 94 | 1st full redox, | 10.4 | 17.4 | 1.43 | 1.39 | 1.56 |
| | | stabilized | | | | | |
| | | performance | | | | | |
| | 114 | 2nd full oxidation, | 10.4 | 8.5 | 3.36 | 2.83 | 3.46 |
| | | instant performance | | | | | |
| | 140 | 2nd full oxidation, 26 | 10.4 | 16.1 | 1.57 | 1.52 | 1.70 |
| | | hrs stabilized | | | | | |

It must be noted that the difference between 2.9 A performance ASR (for EIS meas.) and actual 16 A stack operation ASR is much greater for this condition of dry CO₂ feed only. EIS measured a stack ASR of 2.7 Ω·cm² whereas the IV sweep gave 1.6 Ω·cm² at the same point (see FIG. 54 and FIG. 55). As previously mentioned, this difference in total ASR is primarily due to differences in polarization resistances, and the ohmic resistance is expected to remain largely unchanged between 2.9 and 16 A performance. The stack ohmic ASR measured only 0.64 Ω·cm² at this point in testing, much lower than the 1.1 Ω·cm² ohmic resistance measured at the beginning of the stack test. The large drop in ohmic resistance resulting from full redox cycling is consistent with EIS measurements on button cells that started with a higher-than-expected ohmic resistance. The mechanism is believed to be better particle to particle contact resulting from the recrystallization of nickel grains through redox cycling. The average thickness of the electrolyte in this stack is 220 μm, which will contribute a minimum ohmic resistance of 0.5 Ω·cm2. Any ohmic resistance beyond this (^{˜}0.14 Ω·cm2) could be attributed to a combination of electrolyte degradation, contact resistance between layers, and electrode ohmic contributions.

TABLE 8
EIS measurements comparison between initial performance (with
H₂) and post redox cycling performance (without H₂), at 800°
C., 2.9 A operation (PR not representative of 10.4 V performance)

| | | ASR (Ω · cm²) | | |
|---|---|---|---|---|
| | Stack | Total | Total | |
| Gas Flows & Stack Condition | component | ASR | Ohmic | Total PR |
| 4.0 SLPM CO2 & | Cell #5 | 1.70 | 1.08 | 0.61 |
| 0.51 H2/no air | Cell #3 | 1.58 | 1.11 | 0.47 |
| Initial performance | | | | |
| 4.0 SLPM dry CO2 | Cell #5 | 2.77 | 0.62 | 2.15 |
| (no H2)/4 SLPM | Cell #3 | 2.71 | 0.67 | 2.04 |
| air | Stack | 2.66 | 0.64 | 2.02 |
| After 5 partial redox | (Cell Avg.) | | | |
| & 2 full redox | | | | |

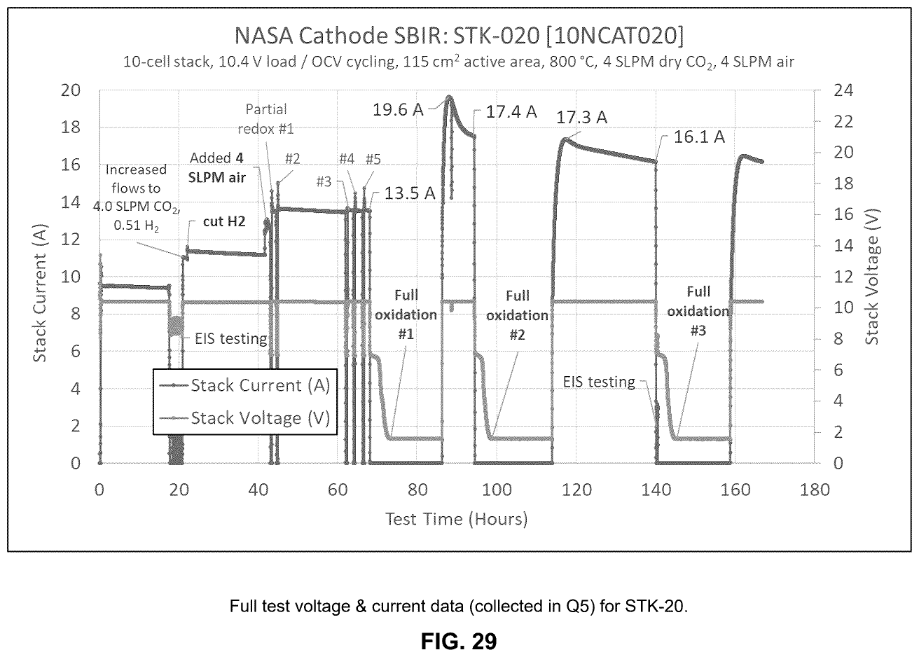

In summary, the first stack test showed that the new fuel electrode material set is both redox tolerant, and that the stack benefits from redox cycling with greater benefit resulting from deeper oxidation of the fuel electrode. The redox cycling results are consistent with button cell testing, providing further confidence that changes made to button cells translate well to stack results. The full voltage and current data set for STK-020 collected is shown in FIG. 29.

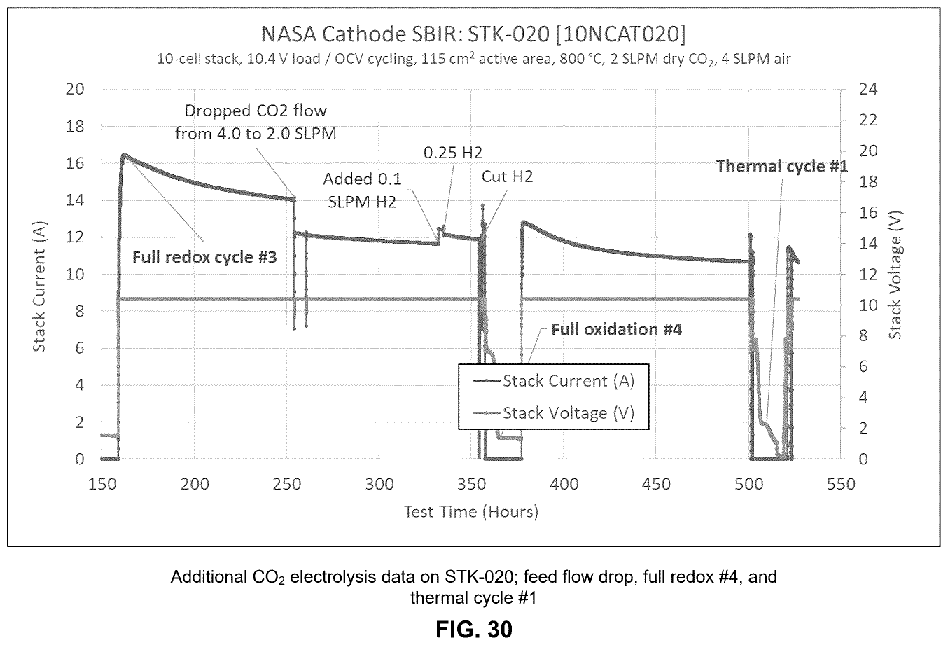

The stack was held at the redox cycling condition of 4 SLPM dry CO₂ feed with 4 SLPM oxygen electrode sweep air at a 10.3 V hold for 100 hours (see FIG. 30). The high CO₂ feed rate was originally selected due to increased performance and to ensure there was plenty of oxidizing gas for redox cycling stress tests. At 250 hours test time the CO₂ feed rate was halved from 4.0 to 2.0 SLPM however, to simulate a more realistic condition (higher utilization) and to conserve CO₂ gas supply. This resulted in a current drop from 14 A to 12 A. After a few days of stability testing a small amount of H2 (0.1 SLPM) was added to the feed with a small increase in performance as shown in the chart (330 hours test time). The stack was then subjected to a 4^{th} full redox cycle to measure the performance boost effect. After peaking at 13 A the stack's performance dropped back to the same trajectory of performance seen before the redox cycle, indicating that the performance boost may be temporary.

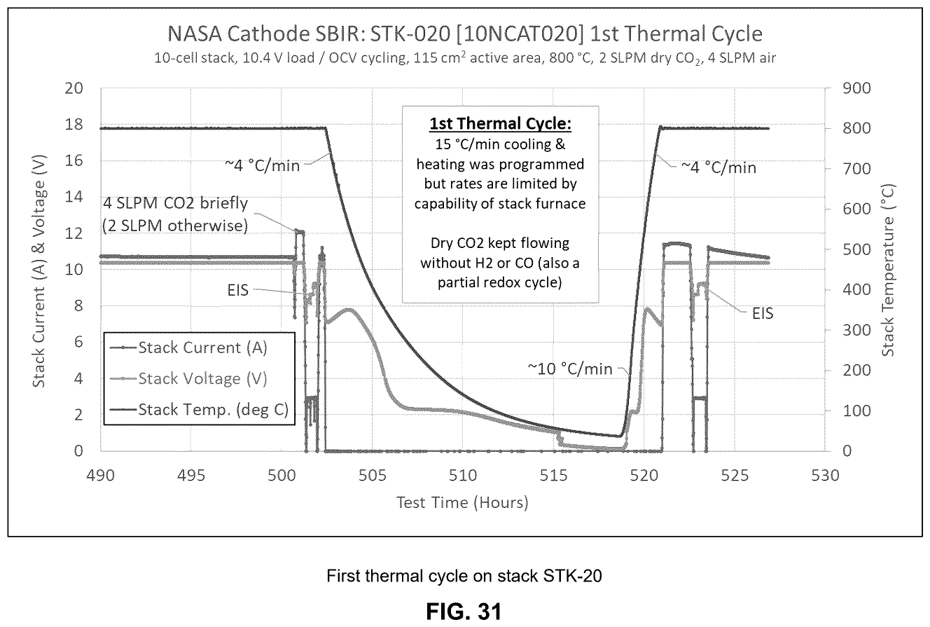

After 500 hours of stack operation the first stack thermal cycle was conducted (FIG. 31). The stack was turned off (swept to OCV from 10.3 V hold, then disconnected from power supply) at the start of cooling and turned on again (10.3 V reapplied) when it reached test temperature. The 2 SLPM of dry CO₂ was kept flowing throughout the thermal cycling, so that while near the test temperature some fuel electrode oxidation took place. In other words, each thermal cycle also doubles as another partial redox cycle. The programmed cooling rate was 15° C./min, however due to the heavy insulation of the stack test kiln the fastest cooling rate achieved was ^{˜}−4° C./min. Likewise, the heating rate was programmed to be 15° C./min but even with 100% power to the elements the fastest rate achieved was about 10° C./min at low temp and dropped to 4° C./min near test temperature.

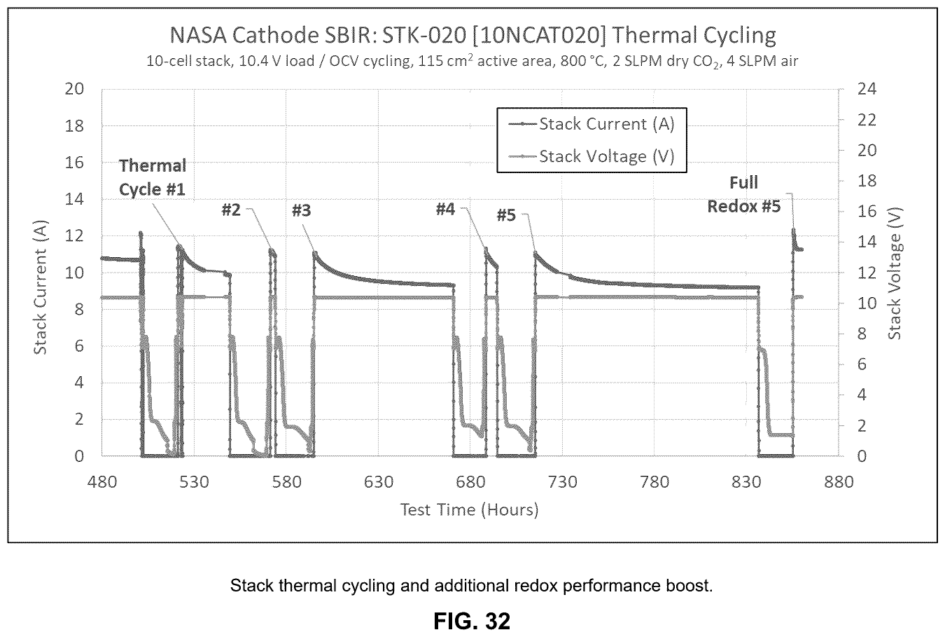

Three more thermal cycles were conducted until 5 cycles were completed as shown in FIG. 32. Each thermal cycle measured a peak performance recovery to 11 A then dropped to similar values (9.5 A by 830 hours test time), showing little to no degradation from the thermal cycling itself and largely following the trend of long-term stability over the 300 hours of test time. These thermal cycling tests demonstrate that the stack is very tolerant to thermal cycling in addition to the proven excellent redox stability. To demonstrate 70 thermal cycles with a rapid 15° C./min heating rate a representative button cell (same material set and glass-ceramic seal as the stack) was used with results detailed in the previous section. After allowing the stack to reach relative stability it was subjected to a 5^{th} redox cycle resulting in a temporary performance boost from 9.5 A to 11 A.

### Co-Electrolysis Utilization & Stability Testing

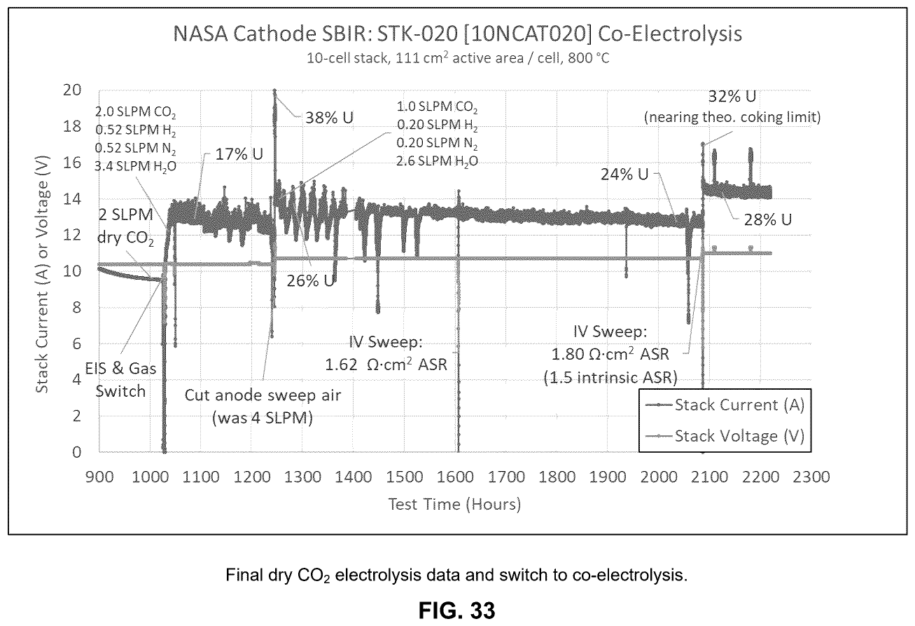

The performance then settled back to 9.5 A by 1000 hours test time (FIG. 33), and the stack was switched from dry CO₂ electrolysis to co-electrolysis of both CO2 and H2O. At the start of co-electrolysis testing the CO₂ flow rate was kept consistent at 2 SLPM, with 3.4 SLPM of H2O added along with 0.52 SLPM each of H₂ and N₂. At the same 10.3 voltage hold, this resulted in a current jump from 9.5 A to 13 A, however the data became very noisy due to inconsistent H₂O delivery. The initial co-electrolysis feed condition results in a product syngas of approximately 2:1H2:CO ratio, which is well suited for Fischer-Tropsch reaction (gas to liquids), however a 3:1 ratio of H2:CO is ideal for a methanation.

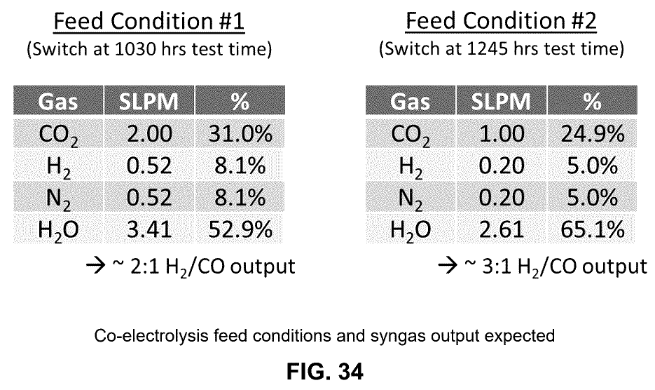

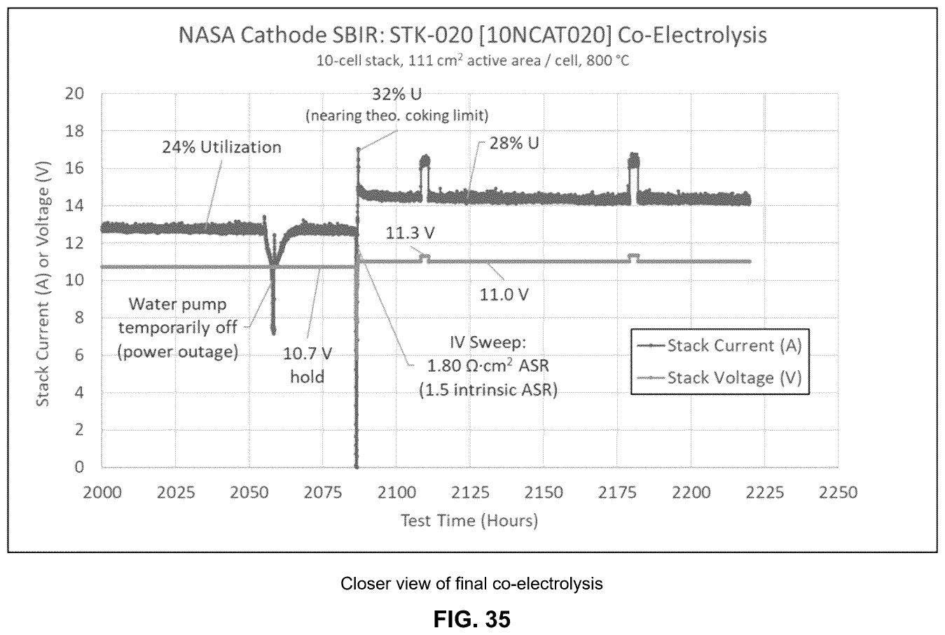

At about 1240 hours test time the stack was switched to a new feed condition to produce 3:1 H2:CO with lower flow rates as specified in FIG. 34. The oxygen electrode sweep air was also turned off at this time to simulate an oxygen collecting stack that would not have oxygen electrode sweep air. The stack was pushed to 11.5 V and 20.0 A (38% utilization) until the safety limit for coking was reached, then backed off to 10.7 V (26% utilization). The stack was then left in this condition for stability testing, however the data remained noisy and oscillated significantly until the stack steam delivery system (water pump set to constant fluid rate feeding overheated bubbler to instantly volatilize to steam) was adjusted to a higher temperature. The stack was tested in this co-electrolysis mode for about 850 hours, and by 2000 hours total test time the performance and stability were still good, ending at 13 A and 24% utilization for 10.7 V. At 2100 hours test time the stack was once again pushed near its theoretical coking limit (11.3 V) then brought to 11.0 V operation to monitor performance in a slightly higher utilization (28%) condition that is still a safe margin away from the coking limit. Stability at the 32% utilization condition was tested for short periods at about 2110 hours and about 2180 hours test time while being monitored and no additional degradation or indications of coking onset were observed (see FIG. 35). The stack was left in the 11.0 V/28% utilization condition.

### ASR Data

Select IV sweep and EIS ASR values collected throughout stack testing are shown in Table 9. Since EIS testing is limited to applying only 2.9 A during measurements there is a significant difference between the polarization resistance measured vs. actual stack operation PR. However, the ohmic resistance measured remains relatively constant regardless of applied current. For this reason, Table 9 lists the total ASR from an IV sweep in the linear regime near the actual operational voltage/current and the EIS measured ohmic resistance, without the EIS measured PR. The listed PR values are simply assumed to be the difference between the total and ohmic ASR measurements.

One notable ASR change was the drop in ohmic resistance (1.0 to 0.64 Ω·cm2) after full redox cycling, which helps explain the significantly increased performance observed (FIG. 35). This indicates that layer to layer contact (potentially interconnects to cell contact) and/or within-layer particle to particle contact improved from the oxidation and re-reduction cycle. Redox cycling results in a large volume expansion and contraction of the Ni/NiO network that has the potential to rearrange the microstructure and bonding points, therefore it is possible that redox cycling helps the fuel electrode material set to become a better interconnected for electronic conduction. Another redox cycle and 200 hours of dry CO₂ electrolysis operation later the ohmic resistance had increased from 0.64 to 0.85 Ω·cm², a similar increase to the polarization resistance when compared to total ASR sweep measurements. The ohmic ASR increased further to 0.93 Ω·cm2 before thermal cycling tests started. Interestingly the ohmic resistance temporarily dropped immediately after the first thermal cycle, which doubles as a partial redox cycle and provides further evidence that redox cycling performance boost is partly based on temporary ohmic resistance improvements.

After 5 thermal cycles (also partial redox cycles) and a 5^{th} full redox cycle the stack was given nearly 200 hours to stabilize, with a measured ohmic ASR increase to 1.02 Ω·cm². The ohmic resistance had returned to its starting value after 1000 hours of operation in dry CO₂ electrolysis and a large but temporary performance boost from full redox cycling. The reasons for ohmic resistance variability need to be investigated, and with material and processing optimizations the low value for ohmic resistance should theoretically be stabilized. The low value of 0.64 Ω·cm² measured after the first two redox cycles is close to the predicted value based on the thickness of the ScSZ electrolyte, therefore increased values represent non-optimal layer-to-layer and/or particle-to-particle contact in the electrodes and current collecting materials.

After 1000 hours of testing the stack was switched to co-electrolysis mode and the ohmic resistance did not measure a significant change. However, the PR dropped by approximately half (1.4 to 0.7 Ω·cm²) based on the drop in total stack ASR from 2.4 to 1.7 Ω·cm². This drop in polarization resistance is thought to be due to the presence of H2O for electrolysis, and higher percentages of H₂O have been shown to drop the ASR further (to 1.5 Ω·cm² for the 2^{nd} co-electrolysis feed condition which contains 65% H2O vs. the 52% of the 1st feed condition [See FIG. 34]). The final three ASR values listed in Table 9 are of the sweep ASR only. As the table shows the ASR slowly increased from 1.5 to 1.8 Ω·cm2 over approximately 800 hours of co-electrolysis operation (a linear fit degradation rate of 0.38 Ω·cm2/1000 hrs).

TABLE 9
Stack ASR data from IV sweeps (total ASR) and EIS measurements (ohmic
ASR). PR is assumed to be the difference between measured values.

| | | | EIS | |
|---|---|---|---|---|
| | | IV Sweep | Measured | Calculated |
| Test | | Measured | Ohmic | PR [Total − |
| Time | | Total ASR | ASR | Ohmic] |
| (hours) | Stack Condition | (Ω · cm²) | (Ω · cm²) | (Ω · cm²) |
| 0 | Initial 1.5 SLPM dry CO2 + 0.19 H2 | 1.76 | 1.01 | 0.75 |
| 140 | 4 SLPM dry CO2, after 2 full redox | 1.51 | 0.64 | 0.87 |
| 357 | 4 SLPM dry CO2, after 3 full redox & 200 | 1.92 | 0.85 | 1.07 |
| | hrs op. | | | |
| 501 | 2 SLPM dry CO2, just before therm cyc #1 | 2.05 | 0.93 | 1.12 |
| 523 | 2 SLPM dry CO2, immediately after therm | 1.99 | 0.79 | 1.20 |
| | cyc #1 | | | |
| 1027 | 2 SLPM dry CO2, settled performance | 2.39 | 1.02 | 1.37 |
| 1029 | 2 SLPM CO2, 0.52 H2, 0.5 N2, 3.4 SLPM | 1.69 | 1.00 | 0.69 |
| | H2O | | | |
| 1246 | 1 SLPM CO2, 0.20 H2, 0.20 N2, 2.6 SLPM | 1.48 | — | — |
| | H2O | | | |
| 1600 | 1 SLPM CO2, 0.20 H2, 0.20 N2, 2.6 SLPM | 1.62 | — | — |
| | H2O | | | |
| 2086 | 1 SLPM CO2, 0.20 H2, 0.20 N2, 2.6 SLPM | 1.80 | — | — |
| | H2O | | | |

In summary, stack testing focused on thermal cycling, but two additional full redox cycles were also performed to result in 5 thermal cycles, 5 full redox cycles, and 10 partial redox cycles total for the stack. After satisfying the thermal cycling requirement, the stack was tested for well over 1000 hours in co-electrolysis mode and measured much higher performance than in CO₂ only mode as well as better stability. A simple linear fit degradation measurement between about 1600 hours and about 2100 hours test time gives a 0.38 Ω·cm²/1000 hrs degradation rate. After 2000 hours of testing, half spent in dry CO2 electrolysis mode and half spent in co-electrolysis mode, the simple IV sweep fit ASR measured 1.8 Ω·cm² (with a calculated 1.5 Ω·cm² intrinsic ASR) in co-electrolysis mode.

### Additional Long-Term CO2, and Steam Electrolysis Testing

STK-20 was switched to steam electrolysis to measure high utilization condition performance and stability (no risk of coking for pure steam electrolysis, allowing for much higher utilization and efficiencies). After steam electrolysis, stack reversibility (fuel cell mode) was tested, followed by a return to dry CO₂ electrolysis and utilization/coking limit testing.

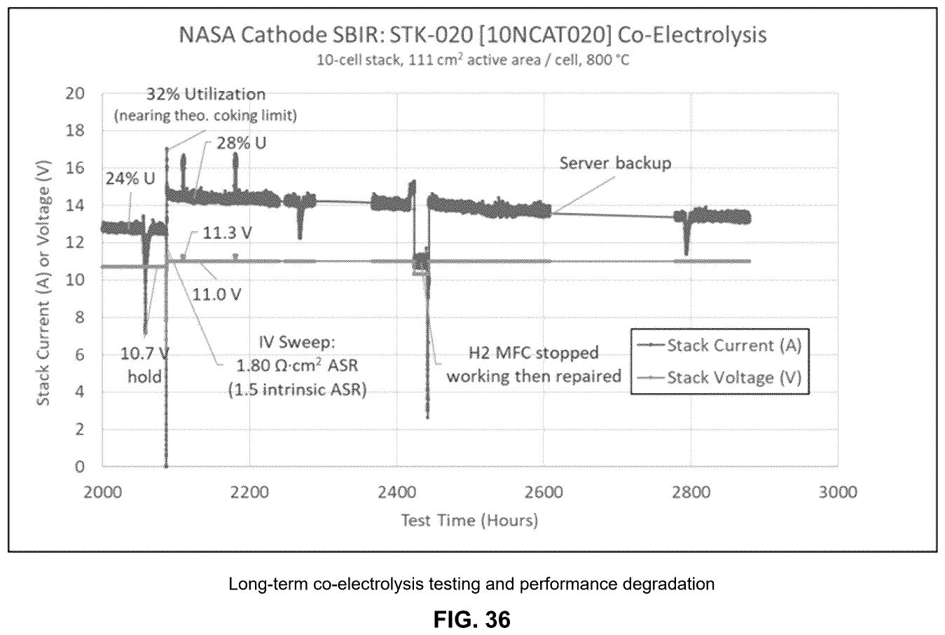

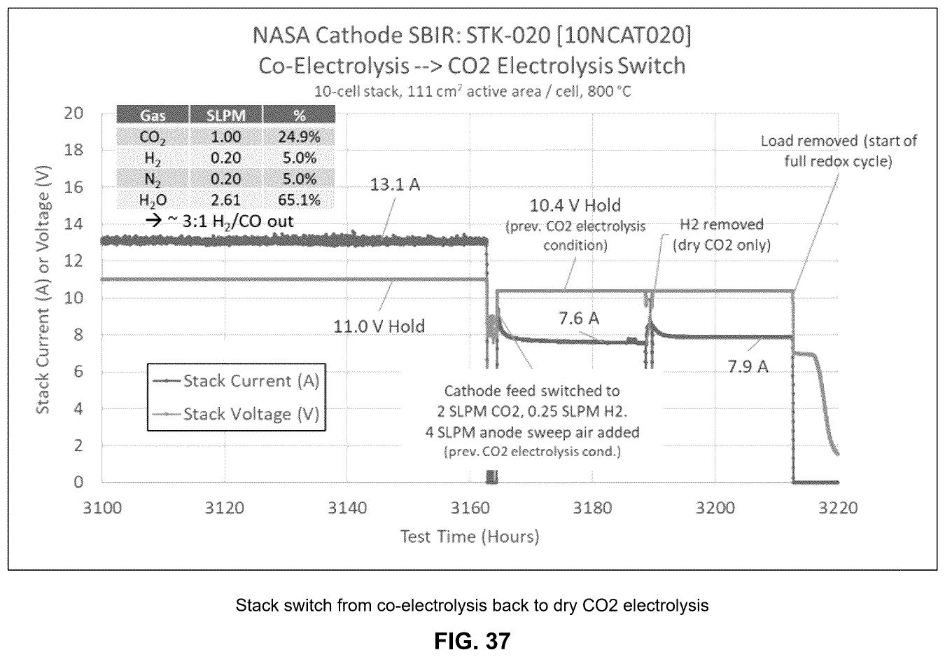

The stack remained in co-electrolysis operation to measure the stability of the newly developed fuel electrode material set in this mode that splits both H2O and CO2 to produce syngas. The CO₂ and H₂O feed rates were selected so that the electrolysis results in a 3:1 ratio of H2:CO which is ideal for Fischer-Tropsch reaction. As shown in FIG. 36 and FIG. 37 the stack remained in the same co-electrolysis conditions for 1000 hours, with the current dropping from 14 A to 13 A in that time with a consistent 11.0 V hold.

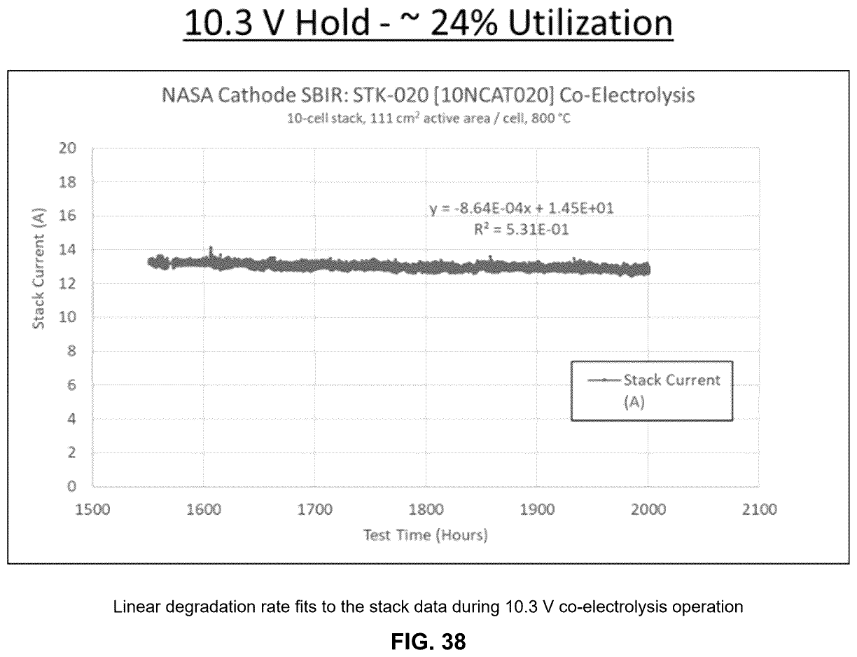

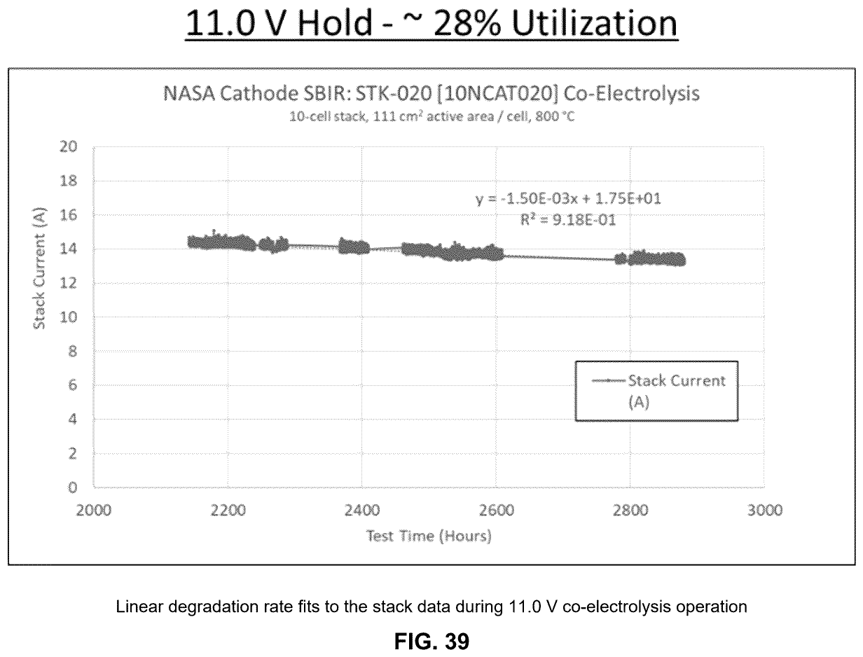

The linear degradation rate was measured during co-electrolysis operation at 11.0 V and compared to the 10.3 V hold operation for the same co-electrolysis feed. As illustrated by FIGS. 38 and 39, the degradation rates in the 10.3 V and 11.0 V holds were measured to be −0.86 mA/hr (−0.7%/1000 hrs) and −1.5 mA/hr (−1.1%/1000 hrs) respectively.

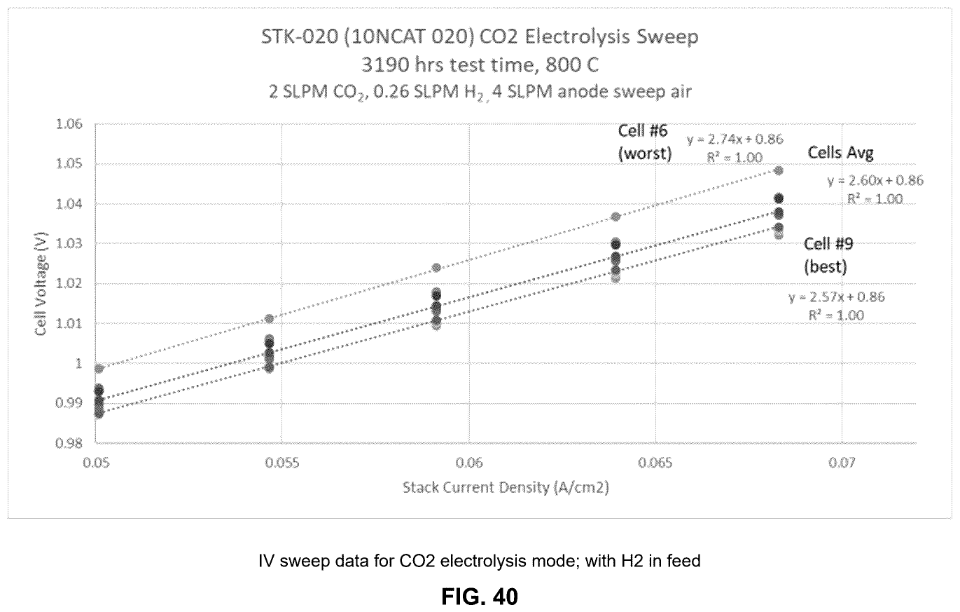

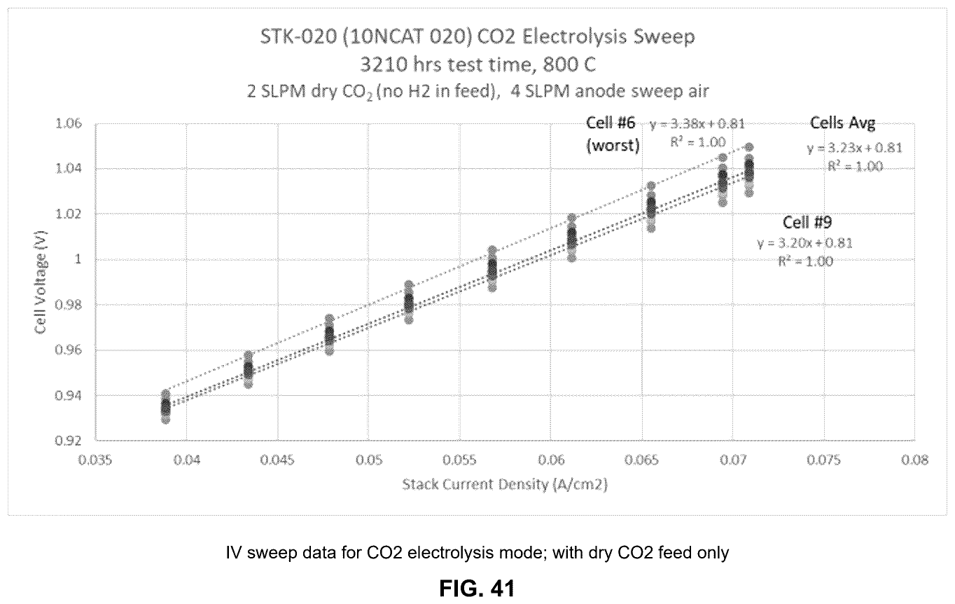

At the end of co-electrolysis testing at 3160 hours of total stack test time the stack was then switched back to CO₂ electrolysis mode and tested with H2 in the feed vs. without. Associated IV-sweeps are shown in FIGS. 40 and 41.

The IV-sweep ASR data set is tabulated in Table 10 and Table 11 for the various modes of operation along with the EIS measured ohmic ASR and calculated polarization resistance.

H₂O electrolysis is more kinetically favored than CO₂ electrolysis, and the ASR results here follow the expected trend. Co-electrolysis ASR is lower than CO₂ electrolysis ASR and CO2 electrolysis with H₂ included in the feed shows lower ASR than dry CO₂ only. Feeding both H2O and CO2 measured 2.0 Ω·cm2 stack ASR whereas dry CO₂ electrolysis measured 3.2 Ω·cm². With H₂ included in the feed the reverse water-gas shift reaction (CO+H₂O⇄CO₂+H₂) will produce H₂O that is then electrolyzed along with the CO2, therefore this condition can also be considered co-electrolysis and is reflected in the stack ASR measurement of 2.6 Ω·cm2 which falls about midway between the ASRs measured for the other two conditions. Cell #6 continued to be the worst cell when measured in these various conditions at the time (note: stack had been in operation for approx. 3200 hours at this point) but was not an extreme outlier (0.1 to 0.2 Ω·cm2 higher ASR than the average).

The ohmic resistances measured for the stack and individual cells remained consistent between the various conditions as expected, with 1.2 Ω·cm² measured for the stack ohmic resistance. About 0.5 Ω·cm² ohmic resistance is expected simply due to the thickness of the electrolyte; therefore, the additional 0.7 Ω·cm² of ohmic resistance results from other aspects that may include electrolyte degradation (likely minor), electrode ohmic contributions and degradation, and/or contact resistances (e.g., cell to interconnect contact). Differences in ASRs between co-electrolysis and CO2 electrolysis modes is entirely due to polarization resistance differences, with the PR jumping from 0.8 to 2.0 Ω·cm² when switching from co-electrolysis back to dry CO₂ electrolysis.

TABLE 2
STK-20 IV sweep and EIS ASR data comparing co-electrolysis
and CO2 electrolysis near 3,200 hours test time at 800° C.

| | | ASR (Ω · cm²) | | |
|---|---|---|---|---|
| | | IV Sweep | EIS | |
| Operational | | (Stack/Avg | Measured | Calculated |
| Mode | Cathode Feed | Cell) | Ohmic | Polarization |
| Co- | 1 SLPM CO2, 2.6 SLPM H2O, | 2.0 | 1.2 | 0.8 |
| Electrolysis | 0.2 SLPM H2 & N2 | | | |
| CO₂ (some | 2 SLPM CO2, 0.26 SLPM H2 | 2.6 | 1.2 | 1.4 |
| H₂O) | | | | |
| CO₂ only (dry) | 2 SLPM CO2 only (dry) | 3.2 | 1.2 | 2.0 |

TABLE 3
STK-020 IV sweep and EIS ASR data comparing co-electrolysis and CO2 electrolysis
for cells avg, #6, and #9 near 3,200 hours test time at 800° C.

| | | | ASR (Ω · cm²) | | |
|---|---|---|---|---|---|
| | | | IV Sweep | EIS | |
| Operational | | | (Total | Measured | Calculated |
| Mode | Cathode Feed | Cell | Cell) | Ohmic | Polarization |
| Co- | 1 SLPM CO₂, 2.6 | Cell # 9 (Best) | 1.9 | 1.1 | 0.83 |
| Electrolysis | SLPM H₂O, 0.2 | Cell # 6 (Worst) | 2.2 | 1.3 | 0.89 |
| | SLPM H₂ & N2 | Cells Avg | 2.0 | 1.2 | 0.83 |
| CO₂ | 2 SLPM CO₂, | Cell # 9 (Best) | 2.6 | 1.1 | 1.5 |
| Electrolysis | 0.26 SLPM H₂ | Cell # 6 (Worst) | 2.7 | 1.3 | 1.4 |
| (some H₂O) | | Cells Avg | 2.6 | 1.2 | 1.4 |
| CO₂ | 2 SLPM CO₂ only | Cell # 9 (Best) | 3.2 | 1.1 | 2.1 |
| Electrolysis | (dry) | Cell # 6 (Worst) | 3.4 | 1.3 | 2.1 |
| | | Cells Avg | 3.2 | 1.2 | 2.0 |

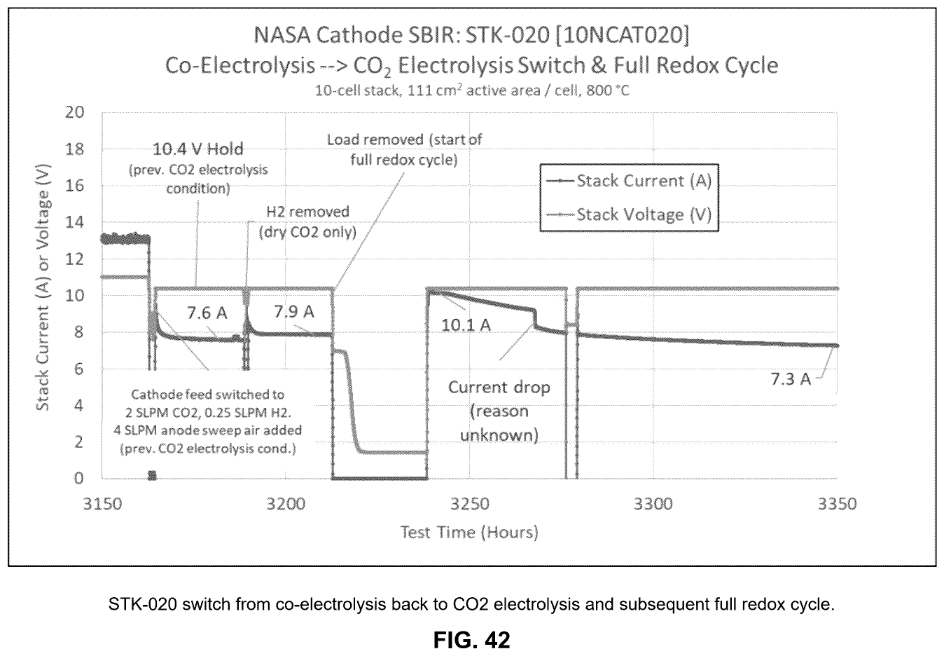

After long-term co-electrolysis testing the stack was switched back to CO₂ electrolysis at approx. 3,160 hours test time then subjected to another full redox cycle (the 6th total full redox cycle) and the performance was allowed to settle as shown in FIG. 42. Initially the stack was returned to the same CO₂+H₂ electrolysis condition used for the start of testing of this stack, then H2 was removed from the feed at about 3,190 hours resulting in a current of 7.9 A at the 10.4 V hold. This is compared to 9.5 A measured for the same dry CO₂ electrolysis condition (before co-electrolysis testing) at 1,020 hours test time; measuring a drop of 1.6 A in this mode due to the 2,000 hours of co-electrolysis testing. The additional full redox cycle between ^{˜}3,210 to 3,240 hours was conducted in the same way as past full redox cycles; electrolysis operation was halted by bringing the stack to OCV while the dry CO2 feed was left running, and the stack remained at 800° C. to force oxidation of the fuel electrode material set. After returning the stack to 10.4 V operation a temporary performance boost was measured resulting in 10.1 A, however, over 100 hours of operation led to the stack dropping back down in current resulting in 7.3 A by 3,350 hours test time.

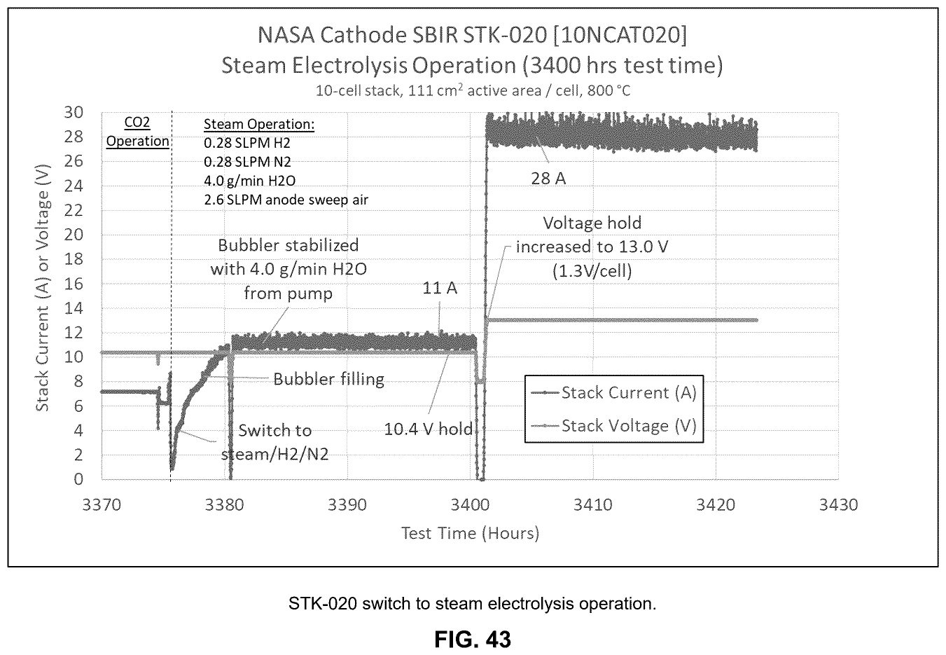

After performance settling in dry CO2 electrolysis mode the stack was then switched to steam only electrolysis at 3,375 hours test time as shown in FIG. 43. Initially the voltage hold was kept the same at 10.4 V to compare the performance difference more easily between the two feed conditions. The current increased from 7.3 A for CO2 electrolysis to 11 A for steam electrolysis with the same voltage hold. The noise seen in the steam electrolysis data is due to non-uniform delivery of the steam using a pump and bubbler assembly. At 3,400 hours test time the voltage hold was increased to 13.0 V (1.3V per cell standard for steam electrolysis testing) resulting in a current jump from 11 to 28 A.

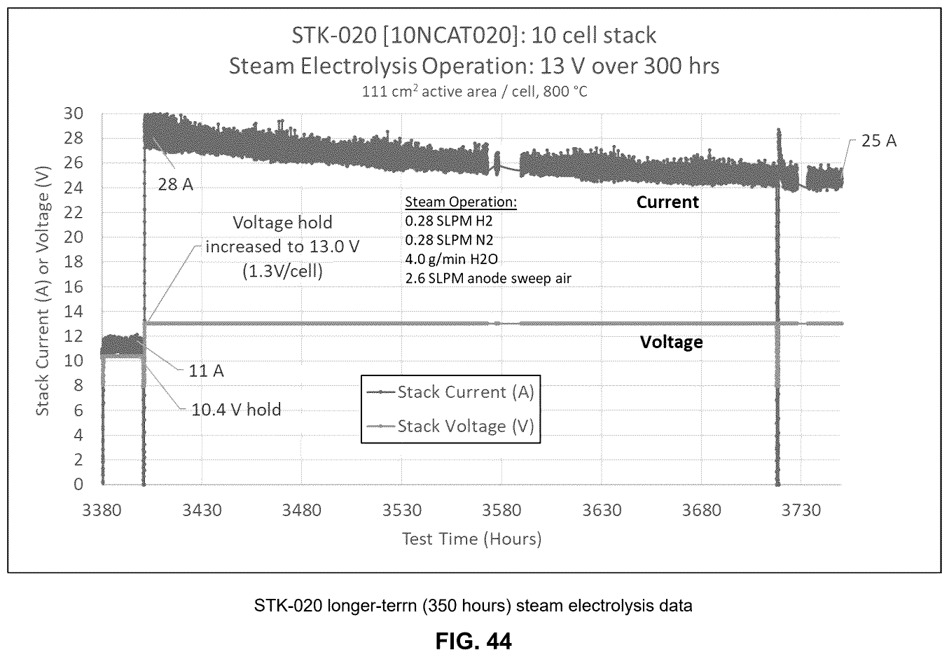

The stack was left in the 13 V steam electrolysis mode for 350 hours with the current dropping from 28 A to 25 A in that time (FIG. 44). An IV sweep at 3,720 hours test time measured 1.75 Ω·cm² ASR for the stack, a slight increase from the 1.67 Ω·cm² ASR measured at the beginning of steam electrolysis testing with a calculated degradation rate of 0.25 Ω·cm² per 1000 hours.

Fuel Cell Operation and Cycling with Electrolysis

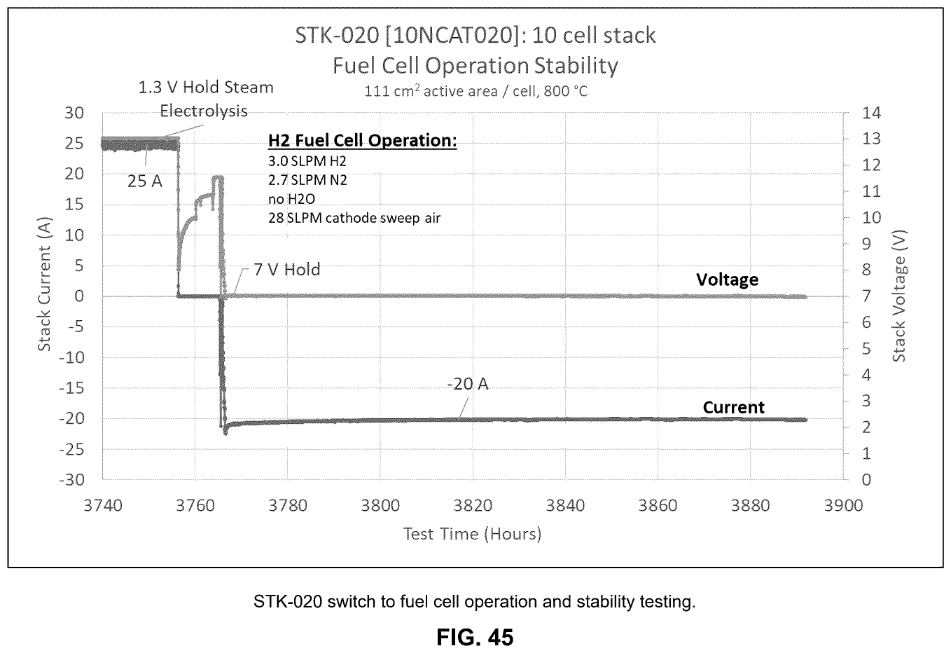

At 3,755 hours test time the stack was switched to fuel cell operation for the first time as shown in FIG. 45. With a standard 7.0 V load (0.7 V per cell) for fuel cell operation the current stabilized at −20 A (specifying negative currents for fuel cell operation as positive currents are used for electrolysis). Excellent stability was measured during this initial 100 hours of fuel cell operation with the current remaining steady at −20 A. An IV-sweep was conducted in fuel cell mode and the result is shown in Table 15 along with the IV sweep measured total ASRs and EIS measured ohmic ASRs of all the operational modes tested between 3,160 and 3,770 hours of stack operation. The 1.5 Ω·cm² total ASR in fuel cell mode is better than the 1.7 Ω·cm² ASR measured in steam electrolysis, however the exothermic fuel cell operation can cause localized heating and therefore better performance. This heating is counteracted to some degree by the high 28 SLPM air flow used in fuel cell mode to help cool and balance the internal stack temperature.

Table 15 shows that regardless of operational mode or gas feed the ohmic resistance remains the same at 1.2 Ω·cm², confirming that the significant differences in ASR between modes is due to electrode performance/polarization resistance. The electrodes perform best in fuel cell operation with only 0.3 Ω·cm² total polarization resistance, compared to 0.5 Ω·cm2 for steam electrolysis and 2.0 Ω·cm² for CO₂ electrolysis.

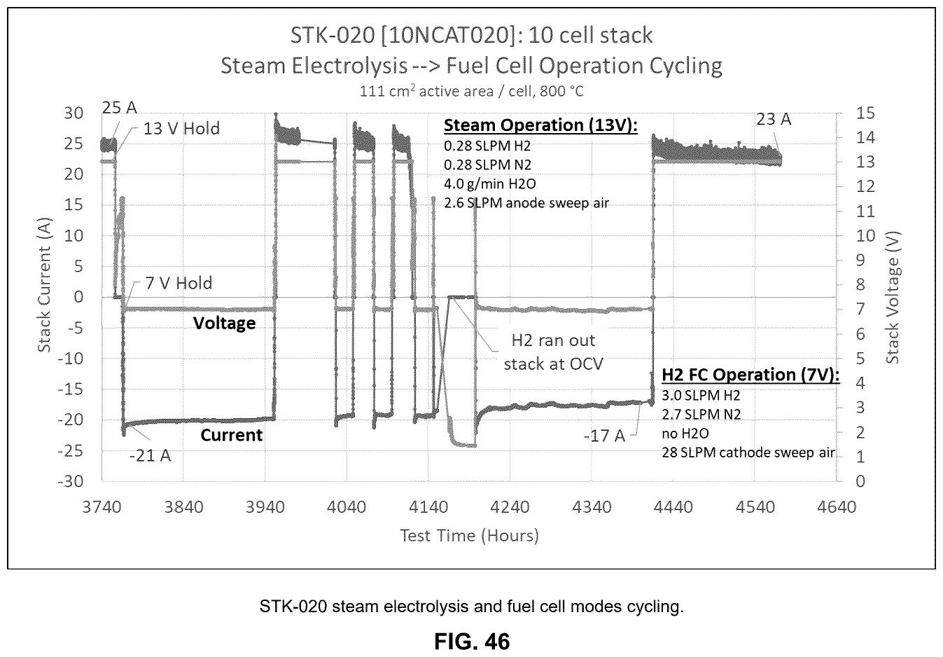

After nearly 200 hours of fuel cell operation stability testing the stack was switched back to steam electrolysis operation and resumed its previous performance as shown in FIG. 46. Cycling back to fuel cell operation also showed a return to previous performance in that mode, demonstrating that the stack is completely reversible without degradation caused by the cycling between electrolysis and fuel cell operation. At about 4,160 hours test time the H2 source ran out resulting in the stack operating in a fuel starved condition for a short time before the stack was brought to OCV. Resuming fuel cell operation at about 4,200 hour test time showed a step change in performance, likely due to the short time spent in a fuel starved condition. The fuel cell performance noise shown in FIG. 46 between about 4,200 hours and about 4,420 hours operation is due to drift and correction in the DC electronic load device's voltage hold (BK Precision model 8502). The current in fuel cell mode degraded to −17 A by 4,400 hours test time, at which point the stack was cycled back to steam electrolysis mode with a return to previous performance. Over 100 hours of electrolysis operation resulted in a current of 23 A, a 2 A drop from the electrolysis performance 900 hours prior before fuel cell and reversibility testing began.

Stack testing focused on measuring the stack's performance in various operational modes beyond dry CO₂ electrolysis. Steam electrolysis was extensively tested, both with and without CO₂ co-feed, as well as fuel cell operation with cycling between fuel cell and electrolysis modes. Stack performance proved to be much better in steam electrolysis than dry CO₂, and excellent reversibility between H₂O electrolysis and H₂ fuel cell operation was demonstrated. While switching between modes appears to have no negative effect on the stack's performance, operational and time-at-temperature degradation remains an issue. STK-020 has continued to produce useful data as it nears 5000 hours of operation.

### Coking Tolerance Test

At low CO₂ conversion, the risk of fuel electrode oxidation is high and would benefit from embodiments of redox tolerance fuel electrode as described herein. At higher CO₂ conversion, the risk of carbon deposition by electrolysis of CO or disproportionation of CO₂ is high. Carbon deposition in the pores of electrodes would disrupt the microstructure and would result in irreversible damage.

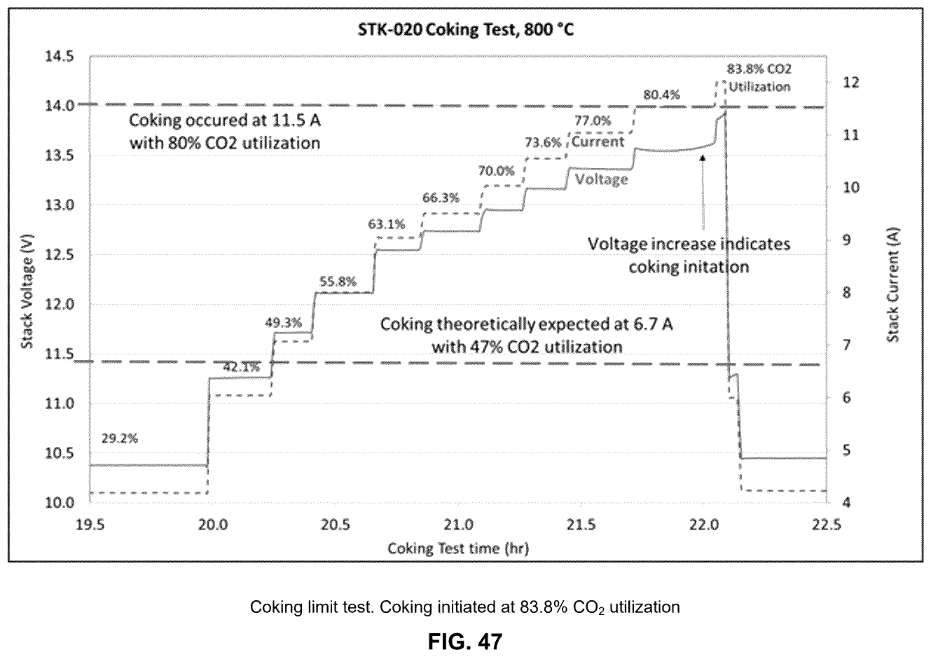

After 5,600 hrs of tests, Stack-20 was returned to dry CO₂ electrolysis mode to test the coking limit, as compared to the theoretical coking limit. Stack current was increased at approximately 10-minute intervals, while the cell voltages were monitored. Coking on an individual cell is indicated by a rapid increase in voltage. Typically, one cell starts coking first, but the overall stack voltage is also observed to increase as coking begins. Under the operating conditions (temperature and inlet CO₂ flow rate), the theoretical coking limit was expected at 6.7 A with 47% CO2 utilization. However, coking was not observed by voltage increase until over 80% CO2 utilization at 11.5 A (FIG. 47).

Remarkably, initial indication of coking was more gradual than is typically seen, and the expected exponential rise in voltage was not observed until utilization increased to 83.8%.

### Stacks (STK-033 & 036)

Two short stacks were built: a 5-cell ISRU stack (STK-036) and a 10-cell FTD (Flow-Through Design) stack (STK-033). The interconnects used for the ISRU stack design allow for oxygen collection from CO₂ and/or H₂O electrolysis. The standard FTD stacks are designed for air flow-through, a requirement for thermal management in fuel cell operation, and are also capable of electrolysis operation without O2 collection. FTD interconnect air side flow fields are open on each end to allow for full flow-through. ISRU interconnects are sealed along the entire stack perimeter and have two O₂ collection ports. The cells used for the ISRU and FTD stacks differed slightly in design as well but were made using identical material sets. One material set difference between the stacks and STK-020 is the use of single layer NMZ backbone instead of double layer NMZ used in STK-020. The NMZ layers were infiltrated and calcined through 6 cycles with NCC85 fuel electrode material, then the new NCAP material was printed and left green to act as a conforming and current collecting layer, as used for experimental stack STK-020.

The FTD stack was built first and designated STK-033. It has open air channels that are slightly visible on the front (current tabs side) of the stack. STK-033 was leak tested using a pressure decay procedure in which 1.5 psi of N₂ was applied to the interior of the stack and the leak rate measured as a function of time. The stack passed with a leak test result of 0.30 g/hr cold. While the leak rate is 3× higher than STK-020, the leak rate is considered very low and is not expected to affect stack performance.

After leak testing, the stack was installed in a test kiln for electrochemical performance evaluation. The stack measured well in CO2 electrolysis, showing 21% higher current than STK-020 for the same voltage hold and operating conditions. Stack redox tolerance was confirmed for both partial and full fuel electrode oxidation, with rapid and complete recovery in each case.

After heat-up and fuel electrode initial reduction in H2/N₂ the feed condition was switched to 1.5 SLPM CO₂ and 0.19 SLPM H₂ to match the initial condition of STK-020. This performed better than the initial performance of STK-020 which measured 1.76 Ω·cm2 total ASR. The primary difference between STK-033 and 020 is the use of single layer and double layer NMZ, respectively. While single layer NMZ may explain the better performance of STK-033, it should be noted that different lots of electrolyte, electrodes, and interconnects were used for the two stacks. However, this verifies that single layer NMZ fuel electrode backbone works well in a stack, as it was previously only measured in button cells.

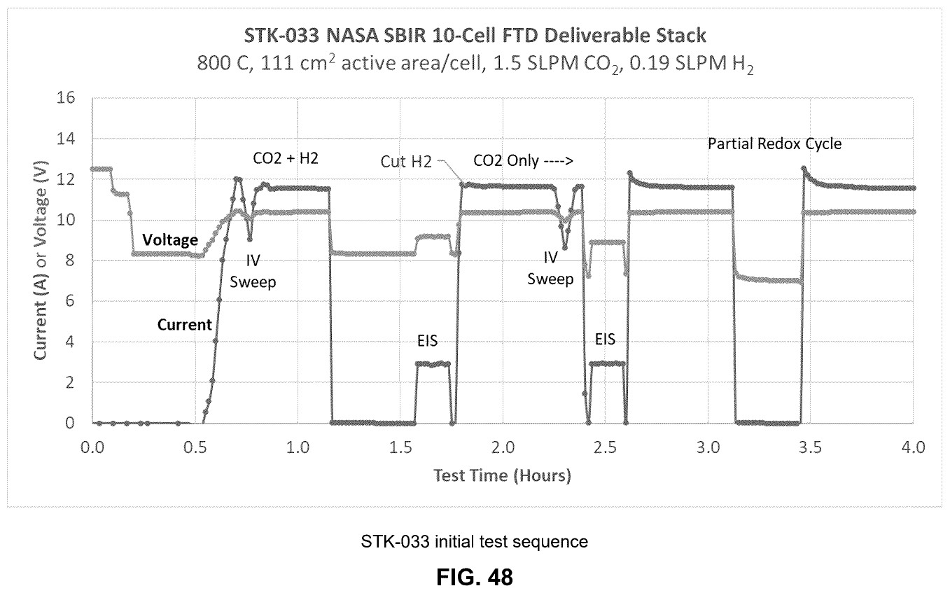

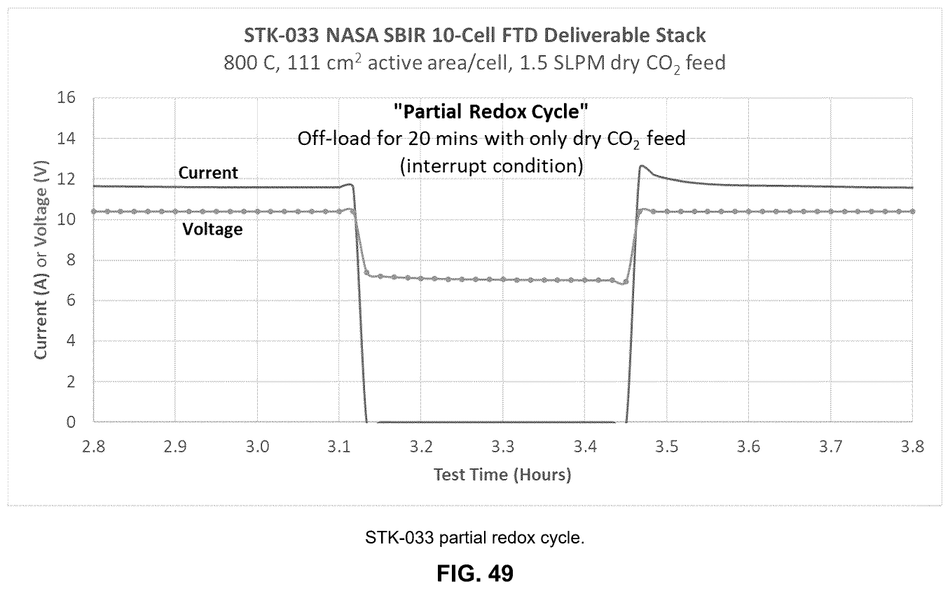

After measuring stack performance with CO₂+H₂ feed, the OCV was measured again followed by EIS to determine the ohmic resistance of the stack (FIG. 48). The stack was held again at 10.4 V then the H₂ was removed for the remainder of CO₂ electrolysis testing. Removing H2 did not result in a significant change in stack current. Voltage hold, IV sweep, and EIS data were collected in the dry CO₂ only condition before the stack was subjected to a standard partial redox cycle. The partial redox cycle represents an interrupted operation condition in which voltage is removed (brought to OCV) but the dry CO₂ remains flowing, allowing for the produced CO to be swept out to result in partial oxidation of the fuel electrode materials. The stack was perfectly tolerant to this partial redox cycle, with the test data shown more closely in FIG. 49.

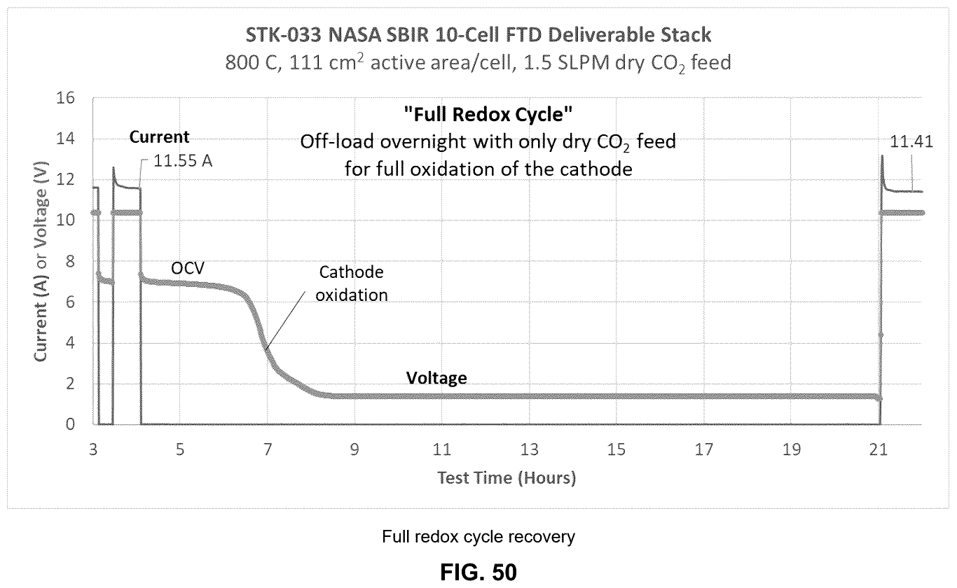

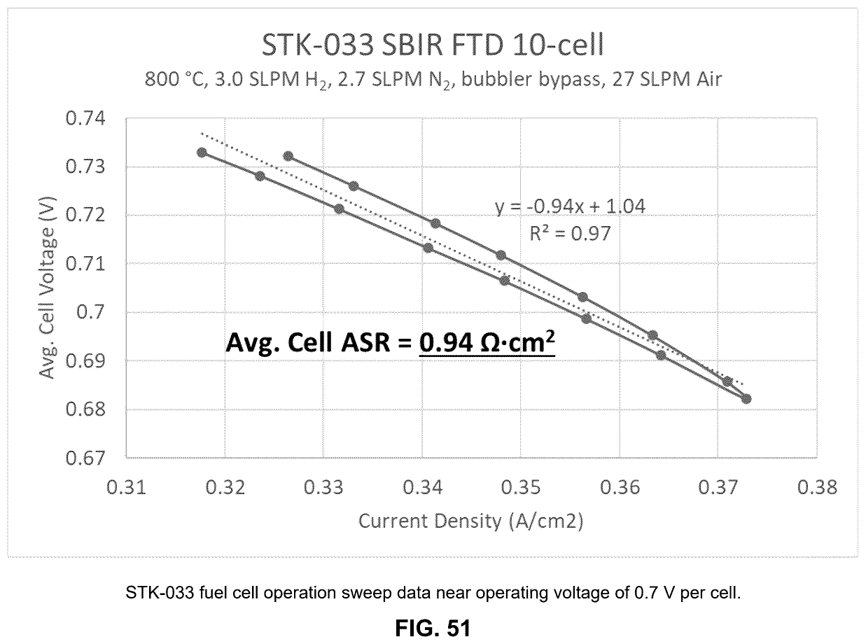

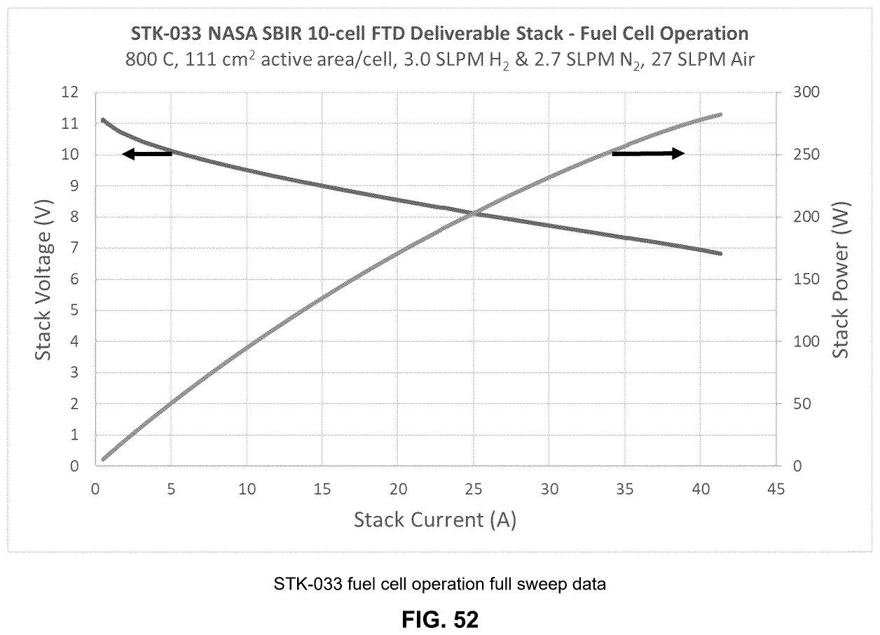

After confirming partial redox tolerance, STK-033 was subjected to a full redox cycle by removing load and keeping CO₂ flowing overnight to allow for full oxidation of the fuel electrode materials. The overnight voltage trace is shown in FIG. 50, where full oxidation is signified by the OCV drop and stabilization at 1.4 V. Full oxidation took approximately 5 hours, but the remaining time at OCV ensured complete oxidation. When the 10.4 V load was applied to the stack, the current recovered in minutes as shown in FIG. 50. After the current peaked to a value higher than the 11.6 A before oxidation, it quickly leveled off to a value only slightly lower, 11.4 A. This small drop in current is more likely due to initial time at temperature degradation of the electrode materials from the overnight hold. The stack has proven to be tolerant to both partial and full oxidation of the fuel electrode material set.

With CO₂ electrolysis performance and redox tolerance verified, testing switched to fuel cell operation to provide expected performance. Fuel cell operation conditions were selected to match those used for STK-020 and are listed in FIG. 87 along with the sweep data near 7.0 V stack operating voltage. The cell measured only 0.94 Ω·cm² total ASR via linear fit to IV sweep data around 7.0 V (0.7 V/cell), showing excellent performance in this mode with 44% lower ASR than the 1.67 Ω·cm² total ASR measured in CO₂ electrolysis just before switching to fuel cell conditions. FIG. 88 shows the full sweep data collected in fuel cell operation. Due to the limitations of the DC load bank that stack voltage was only brought slightly below 7.0 V and did not reach peak power. However, at a standard operating condition of 7.0 V the stack showed good performance of 39.5 A and 276 W.

While certain illustrative embodiments and features have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

The scope of the present invention is defined by the appended claims.

What is claimed is:

1. A fuel electrode for use in a solid oxide electrochemical apparatus, the fuel electrode comprising:
an electron conductor comprising:
oxide-dispersed Nickel (Ni); and
an oxygen ion conductor comprising doped ceria.

2. The fuel electrode of claim 1, wherein the electron conductor further comprises copper.

3. The fuel electrode of claim 2, wherein an oxide is dispersed within grains of nickel-copper alloy.

4. The fuel electrode of claim 3, wherein the oxide comprises magnesium oxide dispersed within grains of nickel-copper alloy.

5. The fuel electrode of claim 1, wherein the electron conductor further comprises magnesium oxide.

6. The fuel electrode of claim 5, wherein the oxide-dispersed nickel comprises magnesium oxide dispersed within grains of nickel.

7. The fuel electrode of claim 1, further comprising a doped ceria infiltrant.

8. The fuel electrode of claim 7, wherein the doped ceria infiltrant comprises one or more of Sm doped ceria and Gd doped ceria.

9. The fuel electrode of claim 7, wherein the doped ceria infiltrant comprises one or more of Pr doped ceria and Co doped ceria.

10. The fuel electrode of claim 7, wherein the doped ceria infiltrant comprises one or more of Sm doped ceria, Pr doped ceria, and Co doped ceria.

11. The fuel electrode of claim 10, wherein the doped ceria infiltrant comprises between about 0 to about 0.2 atom fraction Sm doped ceria, between about 0 to 0.3 atom fraction of Pr doped ceria, and between about 0 to 0.2 atom fraction of Co doped ceria.

12. The fuel electrode of claim 1, wherein the fuel electrode further comprises a backbone structure and wherein at least a portion of the electron conductor and a portion of the oxygen conductor are infiltrated into the backbone structure.

13. The fuel electrode of claim 12, wherein the backbone structure comprises one or more of doped ceria and doped zirconia.

14. The fuel electrode of claim 12, wherein the backbone structure comprises nickel.

15. The fuel electrode of claim 13, wherein the backbone structure comprises magnesium oxide dispersed within the grains of nickel.

16. The fuel electrode of claim 1, further comprising a current collector.

17. The fuel electrode of claim 16, wherein the current collector comprises nickel and magnesium oxide.

18. The fuel electrode of claim 16, wherein the current collector comprises doped ceria.

19. The fuel electrode of claim 16, wherein the current collector comprises copper.

20. The fuel electrode of claim 16, wherein the current collector comprises a precious metal.

21. The fuel electrode of claim 2, wherein the ratio of nickel to copper in the electron conductor ranges from about 99:1 to about 40:60.

22. The fuel electrode of claim 4, wherein the ratio of nickel and copper to magnesium oxide ranges from about 99:1 to about 40:60.

23. The fuel electrode of claim 1, wherein the ratio of electron conductor to oxygen conductor ranges from about 30:70 to about 70:30.

24. A solid oxide electrochemical cell, comprising: an electrolyte, the fuel electrode of claim 1 in operable communication with the electrolyte, an oxygen electrode in communication with the electrolyte, and a power supply in operable communication with the fuel electrode and the oxygen electrode, the solid oxide electrochemical cell configured to operate as a solid oxide electrolysis cell and a solid oxide fuel cell, wherein the solid oxide electrolysis cell is configured to electrolyze one or more of carbon dioxide and steam.

25. The solid oxide electrochemical cell of claim 24, further configured to convert more than about 30% of carbon dioxide to carbon monoxide when operating as a solid oxide electrolysis cell with carbon dioxide as a feed.

26. The solid oxide electrochemical cell of claim 25, further configured to convert more than about 50% of carbon dioxide to carbon monoxide when operating as a solid oxide electrolysis cell with carbon dioxide as a feed.

27. The solid oxide electrochemical cell of claim 26, further configured to convert more than about 75% of carbon dioxide to carbon monoxide when operating as a solid oxide electrolysis cell with carbon dioxide as a feed.

28. The solid oxide electrochemical cell of claim 24, further configured to reduce an oxidated fuel electrode without the use of an external reducing gas.

29. A solid oxide electrochemical cell stack, comprising:
a plurality of the solid oxide electrochemical cells of claim 24;
at least one interconnect in fluid communication with a pair of solid oxide electrochemical cells; and
wherein the power supply is in communication with at least one interconnect.

30. A method of manufacturing a solid oxide electrochemical cell configured to operate as a solid oxide electrolysis cell and a solid oxide fuel cell, wherein the solid oxide electrolysis cell is configured to electrolyze one or more of carbon dioxide and steam, the method comprising:
creating an electrolyte;
screen printing a fuel electrode backbone structure onto the electrolyte;
sintering the backbone structure to the electrolyte;
infiltrating at least one fuel electrode precursor into the backbone structure, wherein the fuel electrode precursor comprises nickel, magnesium, and cerium;
calcining the infiltrated fuel electrode backbone structure to produce a fuel electrode comprising nickel oxide, and cerium oxide;
screen printing an oxygen electrode to an opposing side of the electrolyte from the fuel electrode; and
applying a current collector to one or more of the fuel electrode and the oxygen electrode, where the fuel current collector comprises nickel, magnesium oxide, and doped ceria.

31. A method of using a solid oxide electrochemical cell, comprising:
providing a solid oxide electrochemical cell comprising:
an electrolyte;
a fuel electrode in operable communication with the electrolyte, the fuel electrode comprising an electron conductor comprising:
an oxide-dispersed Nickel (Ni); and
an oxygen ion conductor comprising doped ceria;
an oxygen electrode in operable communication with the electrolyte; and
a power supply in operable communication with the fuel electrode and the oxygen electrode;
wherein the solid oxide electrochemical cell is configured to operate as a solid oxide electrolysis cell and a solid oxide fuel cell, wherein the solid oxide electrolysis cell is configured to electrolyze one or more of carbon dioxide and steam;
providing a voltage across the fuel electrode and an oxygen electrode;
feeding a reducing gas and one or more of steam and CO2 into the solid oxide electrochemical cell when operating as solid oxide electrolysis cell;
determining whether a lack of power has caused oxidation of the fuel electrode;
restoring adequate power to the electrochemical cell; and
reducing the oxidized fuel electrode without the use of a reducing gas from a source external to the electrochemical cell.
